(19) United States
(12) Patent Application Publication
(10) Pub. No.: US 2014/0177151 A1
(43) Pub. Date: Jun. 26, 2014

(54) MOBILE TERMINAL

(71) Applicants: Yasutoki Manda, Kanagawa (JP); Kazunori Kouno, Osaka (JP); Toshiaki Saitoh, Miyagi (JP); Tomoya Imazu, Shizuoka (JP)

(72) Inventors: Yasutoki Manda, Kanagawa (JP); Kazunori Kouno, Osaka (JP); Toshiaki Saitoh, Miyagi (JP); Tomoya Imazu, Shizuoka (JP)

(73) Assignee: PANASONIC CORPORATION, Osaka (JP)

(21) Appl. No.: 13/979,742

(22) PCT Filed: May 24, 2012
(86) PCT No.: PCT/JP2012/003406

§ 371 Date: Jul. 15, 2013

(30) Foreign Application Priority Data
Jul. 15, 2011 (JP) 2011-156535
Dec. 12, 2011 (JP) 2011-271249

(51) Int. Cl. G06F 1/16

(52) U.S. Cl. CPC G06F 1/1626; G06F 1/1633
USPC 361/679.3; 361/679.56

(57) ABSTRACT

A mobile terminal 10 includes a fixing member 20 which fixes a plate shaped member 18 to a case 13 of a casing 12. The fixing member 20 is formed substantially in the shape of a frame including a first member 21 to a fifth member 25 extending along a first side surface 35 to a fourth side surface 38 of the case 13. The first member 21 to the fifth member 25 have sectional forms which are engaged with edge parts 18B of the plate shaped member 18 and engaged with stepped surfaces 46 of the case 13. The fixing member 20 is formed to be deformable so that a dimension L1 of a space between the fourth member 24 and the fifth member 25 may be increased or decreased.

### TECHNICAL FIELD

The present invention relates to a mobile terminal in which a plate shaped member is mounted on a mounting surface along the direction of thickness of a casing and a fixing member is provided that fixes the plate shaped member to the casing.

### BACKGROUND ART

As shown in FIG. 31, a mobile electronic device 200 includes a display device accommodated in a casing 201, a plate shaped member 203 for protecting the display device and a fixing member 205 for fixing the plate shaped member 203 to the casing 201 for instance, see patent literature 1).

The fixing member 205 is formed substantially in the shape of U in a plane having a first member 206 along a first side surface 201A of the casing 201, a second member 207 and a third member 208 respectively along a second side surface 201B and a third side surface 201C adjacent to the first side surface 201A.

The fixing member 205 has a substantially U-shaped sectional form engaged with an edge part of a surface of a panel and engaged with grooves 209 provided in the first side surface 201A, the second side surface 201B and the third side surface 201C.

Accordingly, in the mobile terminal 200 of the patent literature 1, the fixing member 205 is attached to the casing 201 so as to insert the fixing member 205 to the casing 201 along an attaching direction on the second side surface 201B and the third side surface 201C. Thus, the plate shaped member 203 is fixed to the casing 201.

### CITATION LIST

### Patent Literature

Patent Literature 1: JP-A-2010-081570 (Abstract, FIG. 3)

### SUMMARY OF INVENTION

### Technical Problem

Here, in the mobile electronic device 200 of the patent literature 1, under a state that the plate shaped member 203 is fixed to the casing 201 by the fixing member 205, the plate shaped member 203 is fixed in two corners 201D and 201E of four corners 201D to 201G of the casing 201.

Accordingly, in order to fix the plate shaped member 203 in the four corners 201D to 201G, a plurality of fixing members are necessary.

However, when the four corners 201D to 201G of the casing 201 are fixed by the plurality of plate shaped members, strength differences arise in the vicinity of boundaries of the plurality of members. Thus, there is a room for improvement from this point of view.

The present invention is devised to solve the above-described problems and it is an object of the present invention to provide a mobile terminal in which a plurality of members do not need to be used to fix a plate member to a casing and strength differences in the vicinity of boundaries of a plurality of members can be eliminated.

Further, it is an object of the present invention to provide a mobile terminal which can adopt a large display device.

Further, it is an object of the present invention to provide a mobile terminal which can be thinned and enlarge a display device relative to a plane area of the mobile terminal.

### Solution to Problem

A mobile terminal according to an invention includes:

a casing having a substantially rectangular form in plane with a prescribed thickness;

a plate shaped member mounted on a mounting surface in one side along the direction of thickness of the casing; and

a fixing member configured to fix the plate shaped member to the casing, wherein

the fixing member is formed substantially in a shape of a frame including a first member extending along a first side surface intersecting the mounting surface in the casing, a second member and a third member connected to the first member and respectively extending along a second side surface and a third side surface respectively adjacent to the first side surface, a fourth member connected to the second member, adjacent to the second side surface and extending along a part of a fourth side surface opposite to the first side surface, a fifth member connected to the third member and extending along a part of the fourth side surface and a parting section provided between the fourth member and the fifth member, and has a sectional form in which the first member to the fifth member are engaged with edge parts of a surface directed to an opposite side to the casing in the plate shaped member and engaged with stepped surfaces directed to an opposite side to the plate shaped member in the casing, and the fixing member is deformable so that a dimension of a space between the fourth member and the fifth member may be increased or decreased.

The fixing member is formed substantially in a frame shape by the first member, the second member, the third member, the fourth member and the fifth member.

Accordingly, the plate shaped member can be assuredly fixed to the casing in one pairs of side surfaces which respectively hold the four angular parts in the casing of the substantially rectangular shape in plane by the first member, the second member, the third member, the fourth member and the fifth member.

Thus, the plate shaped member can be fixed to the casing only by providing the fixing member as one member.

Thus, a structure is not necessary which uses a plurality of members to fix the plate shaped member to the casing as in the usual device and the strength differences in the vicinity of the boundaries of the plurality of members can be avoided.

Further, since the structure can be simplified, a parts cost can be reduced or assembling processes can be simplified.

In a mobile terminal according to the invention, planar angular parts of the casing may be formed in the shapes of circular arcs,

the fixing member may have bent parts provided correspondingly to the angular parts, and

the bent parts may have sectional forms engaged with the surface of the plate shaped member and the stepped surfaces.

Further, the bent parts are formed in the fixing member correspondingly to the angular parts of the casing. The bent part has a sectional form engaged with the surface of the plate shaped member and the stepped surface.

Thus, the plate shaped member can be assuredly fixed to the casing by the fixing member likewise in the four angular parts of the casing.

In a mobile terminal according to the invention,

a central part of at least one of the second member and the third member in the longitudinal direction may be formed in a planar shape so that the central part is higher in its contact pressure to the casing than both end parts in the longitudinal direction.

Since the contact pressure of at least one of the second member and the third member in the central part in the longitudinal direction is made to be high, the second member or the third member can be more effectively held on the casing.

Thus, the second member or the third member formed to be relatively long can be more preferably prevented from floating.

A mobile terminal according to an invention includes:

a casing having a prescribed thickness;

a plate shaped member mounted on a mounting surface in one side along a direction of thickness of the casing; and

a fixing member substantially having the shape of C in section which is engaged with an edge part of a surface directed to an opposite side to the casing in the plate shaped member and engaged with a stepped surface directed to an opposite side to the plate shaped member in the casing, wherein

the fixing member is formed substantially in the shape of a frame turned along a side surface of the casing and having a parting section provided in a part and can be attached to the casing along an attaching direction parallel to the surface, and

one end and the other end in the fixing member can be more largely separated than a maximum dimension of the casing in the direction of width extending along the surface and intersecting at right angles to the attaching direction.

The fixing member is formed substantially in the shape of a frame turned along the side surface of the casing and having a parting section provided in a part. In such a way, since the fixing member is turned along the side surface of the casing, the plate shaped member can be assuredly fixed to the casing in the side surface of the casing.

Thus, the plate shaped member can be fixed to the casing only by providing the fixing member as one member.

Accordingly, a structure is not necessary which uses a plurality of members to fix the plate shaped member to the casing as in the usual device and the strength differences in the vicinity of the boundaries of the plurality of members can be avoided.

Further, since the structure can be simplified, a parts cost can be reduced or assembling processes can be simplified.

A mobile terminal according to an invention includes:

a casing;

a display device supported by the casing;

a protecting panel laminated on the display device; and

a support member which fixes the display device and the protecting panel to the casing,

wherein the support member includes a first member parallel to a display end face and a protecting end face which are along a same surface, a second member connected to the first member to cover an edge part in a surface of the protecting panel, and a third member provided in an opposite side to the second member in the first member and fixed to the casing.

The display device is supported on the casing, the protecting panel is laminated on the display device and the display device and the protecting panel are fixed together to the casing by the support member.

Thus, since the display device having the substantially same dimension as that of the protecting panel can be used, the display device of a large size can be used.

In a mobile terminal according to the invention,

the support member may be formed in a shape of U in section in which the second member and the third member are substantially parallel to each other and a stepped surface with which the third member can be engaged is formed in a side surface of the casing.

The third member is provided in the support member and the third member is engaged with the stepped surface of the side surface of the casing. Thus, the display device and the protecting panel can be assuredly fixed to the casing.

In a mobile terminal according to the invention,

the display end face and the protecting end face may be provided along a same surface.

Here, the protecting panel is configured to have a form having substantially the same dimension as that of an outer form of the casing.

Accordingly, when the end face of the display device and the end face of the protecting panel are provided along the same surface, the display device having a maximum dimension of the substantially same form as the dimension of the outer form of the casing can be used.

In a mobile terminal according to the invention, the support member may be formed with metal.

Since the support member is formed with the metal, the strength of the support member can be improved. Further, when the strength of the support member is improved, a dimension of thickness of the support member can be reduced.

Thus, when the dimension of thickness of the support member is reduced, a step formed on the front side of the protecting panel can be made to be small.

In a mobile terminal according to the invention, a sheet may be laminated on the surface of the protecting panel.

The sheet is laminated on the surface of the protecting panel, so that the surface of the protecting panel can be allowed to correspond to the height of the support member.

Thus, the step formed on the front side of the protecting panel can be eliminated or reduced by the support member.

A mobile terminal according to an invention includes:

a casing;

a display device accommodated in the casing;

a protecting panel laminated on a front side of the display device;

an elastic member which covers a side surface of the display device and is interposed between the casing and the protecting panel; and

a support member which fixes the protecting panel to the casing,

wherein the support member includes a first member which faces a side surface of the protecting panel and the elastic member, a second member connected to the first member to cover an edge part in a surface of the protecting panel, and a third member provided in an opposite side to the second member in the first member and fixed to the casing.

The side surfaces of the display device are covered with the elastic member and the elastic member is interposed between the casing and the protecting panel. Thus, since a seal material can be removed between the display device and the casing or between the protecting panel and the casing, the thickness of the mobile terminal can be reduced.

Further, the second member of the support member can be provided in a position corresponding to the elastic member. Accordingly, the second member can be allowed to come near the side surface of the protecting panel. Thus, since a dimension of width of the second member can be reduced, a screen of the display device can be enlarged relative to a plane area of the mobile terminal.

In addition thereto, a space between the casing and the protecting panel can be sealed by the elastic member and a waterproof property of the display device can be ensured.

Since the support member is configured substantially in the form of the frame having a U shape in section, the protecting panel can be assuredly fixed to the casing by the support member.

Further, the side surfaces of the protecting panel or the side surfaces of the casing can be protected by the support members.

Further, the second member of the support member is turned toward the edge part in the surface of the protecting panel, so that a step is formed in the edge part of the protecting panel. Accordingly, the belly of the palm can be supported by the second member so that the belly of the palm does not come into contact with the protecting panel. Thus, an erroneous operation can be prevented.

In addition thereto, since the second member forms the step in the edge part of the protecting panel, the belly of a finger is allowed to come into contact with the step so that a user may recognize that the finger is located in an end part of the mobile terminal.

A mobile terminal according to the invention may further include a belt part connected to the elastic member and interposed between the display device and the protecting panel.

Thus, a gap between the display device and the protecting panel can be sealed by the belt part to more improve a dust-proof performance between the display device and the protecting panel.

In a mobile terminal according to the invention, the support member may be formed with metal and electrically connected to a circuit board accommodated in the casing.

The support member made of metal is electrically connected to the circuit board. Thus, when a static electricity is applied, the support member can be utilized as a lightening rod and an abnormality of an operation of the display device can be prevented from occurring and an influence to an antenna property can be reduced.

### Advantageous Effects of Invention

In the mobile terminal of the present invention, the fixing member is formed substantially in a frame shape by the first member, the second member, the third member, the fourth member and the fifth member. Accordingly, the plate shaped member can be assuredly fixed to the casing in one pairs of side surfaces which respectively hold the four angular parts in the casing by the fixing member.

Thus, the plate shaped member can be fixed to the casing only by providing the fixing member as one member.

Thus, the strength differences in the vicinity of the boundaries of the plurality of members can be avoided. Further, since the structure can be simplified, a parts cost can be effectively reduced or assembling processes can be simplified.

Further, the fixing member is formed substantially in the shape of a frame so as to be turned along the side surface of the casing. Since the fixing member is turned along the side surface of the casing, the plate shaped member can be assuredly fixed to the casing in the side surface of the casing.

Namely, the fixing member can effectively achieve the same role as that of the fixing member formed substantially in the shape of the frame by the first to the fifth members.

Further, in the mobile terminal of the present invention, the display device is supported on the casing, the protecting panel is laminated on the display device and the display device and the protecting panel are fixed together to the casing by the support member. Thus, since the display device having the substantially same dimension as that of the protecting panel can be used, the display device of a large size can be used.

Further, in the mobile terminal of the present invention, the side surfaces of the display device are covered with the elastic member and the elastic member is interposed between the casing and the protecting panel. Thus, the thickness of the mobile terminal can be reduced and a screen of the display device can be enlarged relative to a plane area of the mobile terminal.

### BRIEF DESCRIPTION OF THE DRAWINGS

FIG. 1 is a perspective view showing a mobile terminal of a first exemplary embodiment according to the present invention.

FIG. 2 is a sectional view taken along a line I-I in FIG. 1.

FIG. 3 is an exploded perspective view showing the mobile terminal in FIG. 1.

FIG. 4 is a perspective view showing an example that a fixing member is attached to a casing of the mobile terminal of the first exemplary embodiment.

FIG. 5 is a perspective view showing an example that the fixing member is fitted to the casing of the mobile terminal of the first exemplary embodiment.

FIG. 6 is a perspective view showing a state that the mobile terminal of the first exemplary embodiment of the mobile terminal is assembled.

FIG. 7 is a plan view showing a fixing member of a second exemplary embodiment according to the present invention.

FIG. 8 is a perspective view showing the fixing member in FIG. 7.

FIG. 9 is an enlarged view of a part II in FIG. 7.

FIG. 10 is a plan view showing a fixing member of a third exemplary embodiment according to the present invention.

FIG. 11 is a perspective view showing the fixing member in FIG. 10.

FIG. 12 is an enlarged view of a part III in FIG. 10.

FIG. 13 is a perspective view showing a fixing member of a fourth exemplary embodiment according to the present invention.

FIG. 14 is a plan view showing an exploded state of a mobile terminal of a fifth exemplary embodiment according to the present invention.

FIG. 15 is a sectional view showing a mobile terminal of a sixth exemplary embodiment according to the present invention.

FIG. 16 is a sectional view showing a mobile terminal of a seventh exemplary embodiment according to the present invention.

FIG. 17A is a plan view showing an example that a fixing member is attached to a casing of the mobile terminal of an eighth exemplary embodiment. FIG. 17B is a plan view showing an example that the fixing member is fitted to the casing of the mobile terminal of the eighth exemplary embodiment.

FIG. 18A is a plan view showing an example that a fixing member is attached to a casing of a mobile terminal of a modified example. FIG. 18B is a plan view showing an example that the fixing member is fitted to the casing of the mobile terminal of the modified example.

FIG. 19 is a perspective view showing a mobile terminal of a ninth exemplary embodiment according to the present invention.

FIG. 20 is an exploded perspective view showing the mobile terminal in FIG. 19.

FIG. 21 is a sectional view taken along a line IV-IV in FIG. 19.

FIG. 22 is an enlarged view of a part V in FIG. 19.

FIG. 23 is a sectional view showing a mobile terminal of a tenth exemplary embodiment according to the present invention.

FIG. 24 is a sectional view showing a mobile terminal of an eleventh exemplary embodiment according to the present invention.

FIG. 24B is a perspective view showing a support member of the eleventh exemplary embodiment.

FIG. 25 is a sectional view showing a mobile terminal of a twelfth exemplary embodiment according to the present invention.

FIG. 26 is a perspective view showing a mobile terminal of a thirteenth exemplary embodiment according to the present invention.

FIG. 27 is an exploded perspective view showing the mobile terminal of the thirteenth exemplary embodiment.

FIG. 28 is a sectional view taken along a line VI-VI in FIG. 26.

FIG. 29 is an exploded perspective view showing a state that a support member of the thirteenth exemplary embodiment is connected to a circuit board.

FIG. 30 is a sectional view showing a mobile terminal of a fourteenth exemplary embodiment according to the present invention.

FIG. 31 is a perspective view showing a usual mobile terminal.

### DESCRIPTION OF EMBODIMENTS

Now, a mobile terminal according to an exemplary embodiment of the present invention will be described hereinafter by referring to the drawings.

### First Exemplary Embodiment

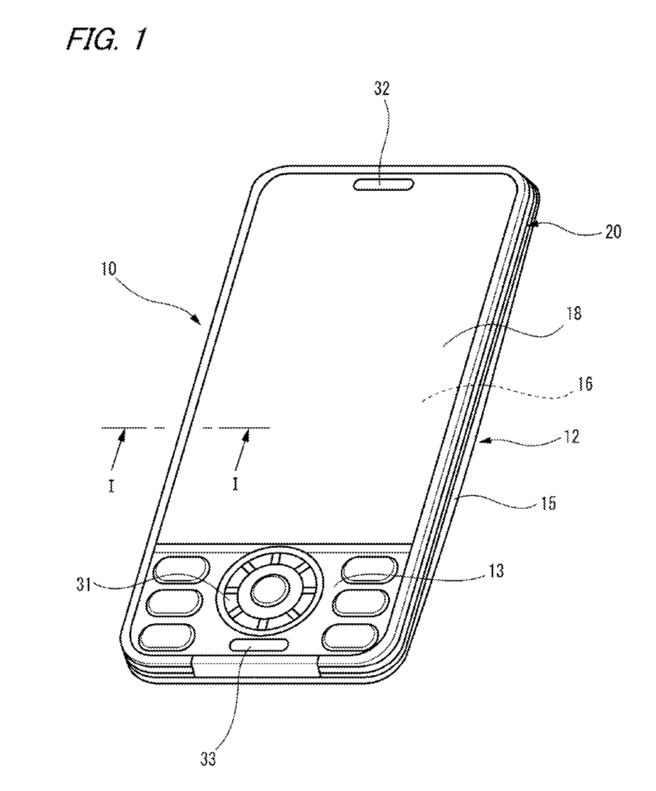

As shown in FIG. 1, a mobile terminal 10 of a first exemplary embodiment of the present invention includes a casing 12 of a substantially rectangular shape in plane with a prescribed thickness, a display part 16 accommodated in the casing 12, a plate shaped member (a panel) 18 which covers the display part 16 and a fixing member 20 which fixes the plate shaped member 18 to the casing 12.

The mobile terminal 10 is a mobile electronic device having an operating part (a key sheet) 31, a receiving part 32 for calling and a transmitting part for calling (not shown in the drawing) provided in the casing 12.

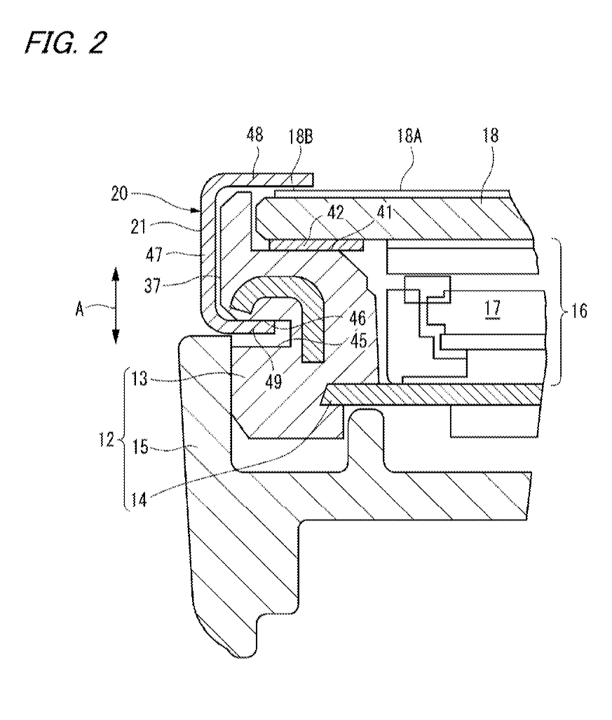

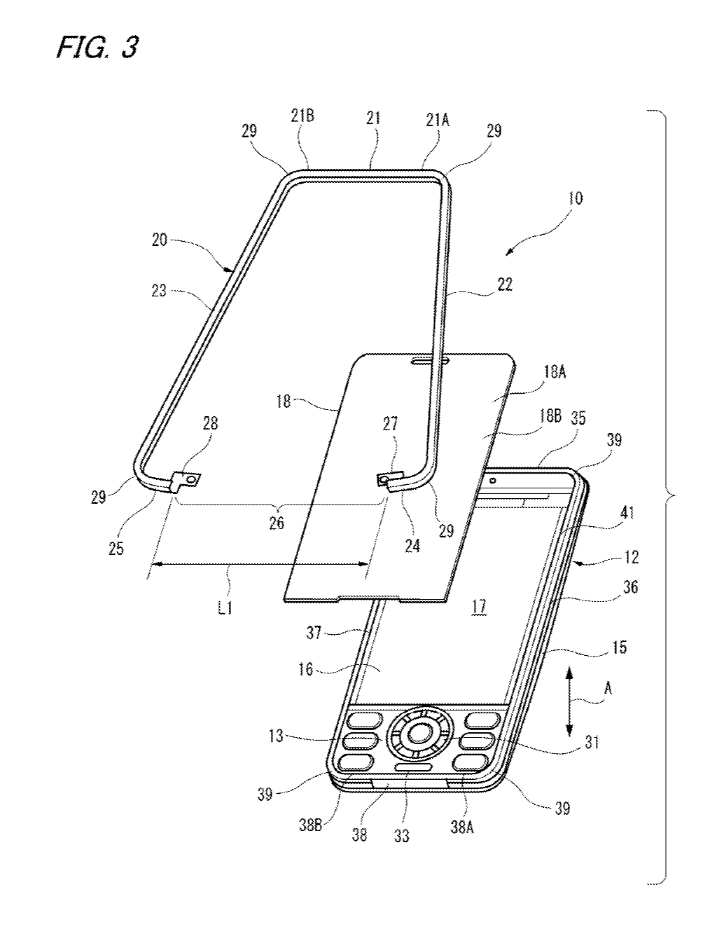

As shown in FIG. 2, the casing 12 includes a case 13 having a recessed part 17 (see FIG. 3) formed to accommodate the display part 16, a plate 14 forming a bottom part of the case 13 and a cover 15 which covers the plate 14.

As shown in FIG. 3, the case 13 is formed substantially in a rectangular shape in plane by a first side surface 35, a second side surface 36, a third side surface 37 and a fourth side surface 38, so that the case 13 has four angles or four corners.

Since the case 13 has the four angles or four corners, four planar angular parts 39 are formed in circular arc shapes in the case 13.

Further, the case 13 has a mounting surface 41 (see also FIG. 2) in one side along a direction of thickness (a direction of an arrow mark A).

The mounting surface 41 is formed substantially in the shape of a rectangular frame along the first side surface 35, the second side surface 36, the third side surface 37 and the fourth side surface 38 of the case 13.

As shown in FIG. 2, the plate shaped member 18 is mounted on the mounting surface 41 through a double-sided tape 42.

As shown in FIG. 2, the third side surface 37 is a side surface intersecting the mounting surface 41 and has a third groove part 45.

The third groove part 45 is formed in parallel with the mounting surface 41 and has a third stepped surface (a stepped surface) 46 directed to a side opposite to the plate shaped member 18.

FIG. 2 is a partly sectional view of the third side surface 37. The first side surfaced 35, the second side surface 36 and the fourth side surface 38 have basically the same structure as that of the third side surface 37.

As shown in FIG. 3, the second side surface 36 and the third side surface 37 are side surfaces respectively adjacent to the first side surface 35. The first side surface 35 and the second side surface 36 respectively have a first groove part and a second groove part like the third side surface 37.

The first groove part and the second groove part are formed in parallel with the mounting surface 41 like the third groove part 45 and have a first stepped surface (a stepped surface) and a second stepped surface (a stepped surface) directed to sides opposite to the plate shaped member 18.

The fourth side surface 38 is a side surface adjacent to the second side surface 36 and opposite to the first side surface 35 and has a fourth groove part like the third side surface 37.

The fourth groove part is formed in parallel with the mounting surface 41 like the third groove part 45 and has a fourth stepped surface (a stepped surface) directed to a side opposite to the plate shaped member 18.

Now, in order to easily understand the structure, the third groove part 45, the first groove part, the second groove part and the fourth groove part are designated as the groove part 45. The third stepped surface 46, the first stepped surface, the second stepped surface and the fourth stepped surface are designated as the stepped surface 46.

As shown in FIG. 2 again, the plate shaped member 18 is formed substantially in a rectangular shape so as to be mounted on the mounting surface 41 of the casing 12 through the double-sided tape 42.

The plate shaped member 18 has an edge part 18B of a surface 18A directed to an opposite side to the casing 12.

As shown in FIG. 3, the fixing member 20 includes a first member 21 along the first side surfaced 35, a second member 22 and a third member 23 along the second side surface 36 and the third side surface 37, and a fourth member 24 and a fifth member 25 along the fourth side surface 38, and a parting section 26 provided between the fourth member 24 and the fifth member 25.

Further, the fixing member 20 has four bent parts 29 provided correspondingly to the planar angular parts 39 of the case 13.

The fixing member 20 is formed substantially in a frame shape by the first member 21, the second member 22, the third member 23 and the fourth member 24 and the fifth member 25. The parting section 26 is formed between the fourth member 24 and the fifth member 25.

Since the second member 22 and the third member 23 are formed to be bent, the fixing member 20 is formed in a leg opened state that the parting section 26 is opened large in an initial state (a non-attached state) of the fixing member 20.

The fixing member is a deformable member so that a dimension L1 of a space between the fourth member 24 and the fifth member 25 may be increased or decreased.

The first member 21 is provided so as to extend along the first side surface 35 of the case 13.

The second member 22 is connected to one end part 21A of the first member 21 and provided so as to extend along the second side surface 36 adjacent to the first side surface 35.

The third member 23 is connected to the other end part 21B of the first member 21 and provided so as to extend along the third side surface 37 adjacent to the first side surface 35.

The fourth member 24 is connected to the second member 22 and provided so as to extend along one part 38A of the fourth side surface 38.

The fourth member 24 has an engaging piece 27.

The engaging piece 27 of the fourth member 24 is engaged with the one part 38A of the fourth side surface 38 by a screw (not shown in the drawing).

The fifth member 25 is connected to the third member 23 and provided so as to extend along one part 38B of the fourth side surface 38.

The fifth member 25 has an engaging piece 28.

The engaging piece 28 of the fifth member 25 is engaged with the one part 38B of the fourth side surface 38 by a screw (not shown in the drawing).

The parting section 26 is provided between the fourth member 24 and the fifth member 25.

When the fixing member 20 is not attached to the casing 12, the dimension L1 of the space of the parting section 26 is opened more than a dimension of width of the case 13.

On the other hand, when the fixing member 20 is attached to the casing 12, the fixing member 20 is deformed to narrow the dimension L1 of the space of the parting section 26.

Thus, the fixing member 20 can be easily attached to the case 13.

In the fixing member 20, the first member 21 to the fifth member 25 and the bent parts 29 are formed to have a same section.

Namely, as shown in FIG. 2, the fixing member 20 has a sectional form engaged with the edge part 18B of the surface 18A in the plate shaped member 18 and the stepped surfaces 46 of the case 13.

The first member 21 to the fifth member 25 and the bent parts 29 are formed with the same sectional form.

Now, referring to FIG. 2, the sectional form of the fixing member 20 will be described below by taking the third member 23 as an example.

The third member 23 of the fixing member 23 includes a web 47 provided along the third side surface 37 of the case 13, a first flange 48 bent from an upper end of the web 47 and a second flange 49 bent from a lower end of the web 47.

The fixing member 20 is formed in the shape of C (the shape of U) in section by the web 47, the first flange 48 and the second flange 49.

When the second flange 49 is inserted to the groove part 45, the second flange 49 is engaged with the stepped surface 46.

Further, the first flange 48 is engaged with the edge part 18B of the plate shaped member 18.

The fixing member 20 is formed substantially in a frame shape by the first member 21, the second member 22, the third member 23, the fourth member 24 and the fifth member 25.

Accordingly, the plate shaped member 18 can be assuredly fixed to the case 13 in the second side surface 36 and the third side surface 37 (one pair of side surfaces) which respectively hold the four planar angular parts 39 in the case 13 of the substantially rectangular shape in plane by the first member 21 to the fifth member 25.

Thus, the plate shaped member 18 can be fixed to the case 13 (namely, the casing 12) only by providing the fixing member 20 as one member.

Thus, a structure is not necessary which uses a plurality of members to fix the plate shaped member to the casing as in the usual device and the strength differences in the vicinity of the boundaries of the plurality of members can be avoided.

Further, since the structure can be simplified, a parts cost can be reduced or assembling processes can be simplified.

Further, the bent part 29 has a sectional form engaged with the surface 18A of the plate shaped member 18 and the stepped surface 46.

Thus, the plate shaped member 18 can be assuredly fixed to the case 13 by the fixing member 20 likewise in the four planar angular parts 39 of the case 13.

Now, a procedure for fixing the plate shaped member 18 to the casing 12 by the fixing member 20 will be described by referring to FIG. 4 to FIG. 6 and FIG. 2.

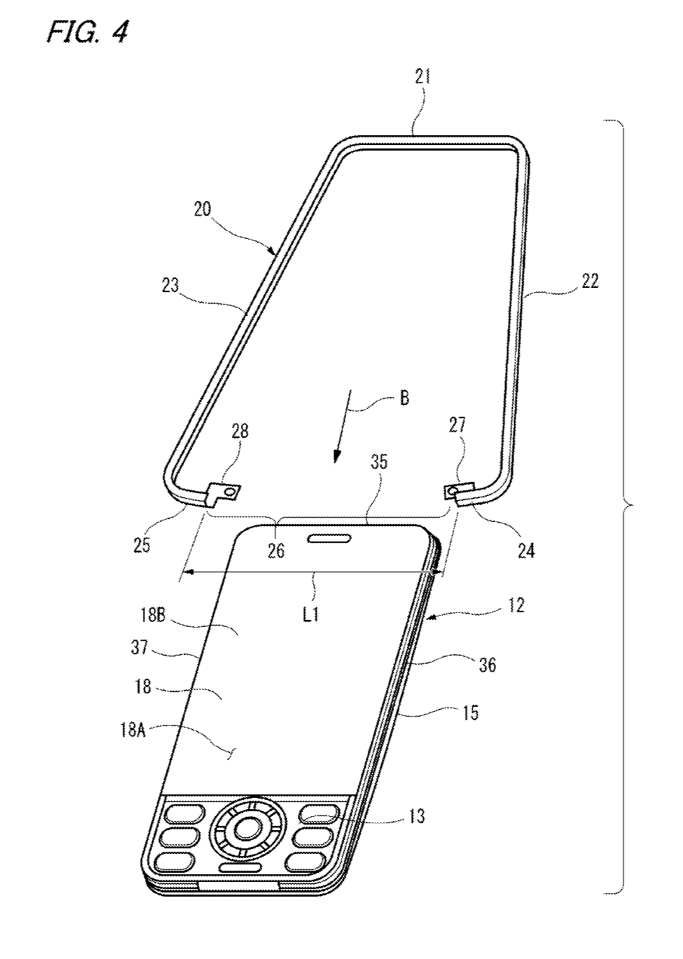

As shown in FIG. 4, the plate shaped member 18 is mounted on the mounting surface 41 of the case 13 through the double-sided tape 42 (see FIG. 2).

Under this state, the fixing member 20 is arranged with the parting section 26 directed toward the casing 12 and the plate shaped member 18 side.

Since the dimension L1 of the space of the parting section 26 is opened more than the dimension of width of the case 13, the fixing member 20 can be moved toward the casing 12 and the plate shaped member 18 with the arranged fixing member 20 left as it is.

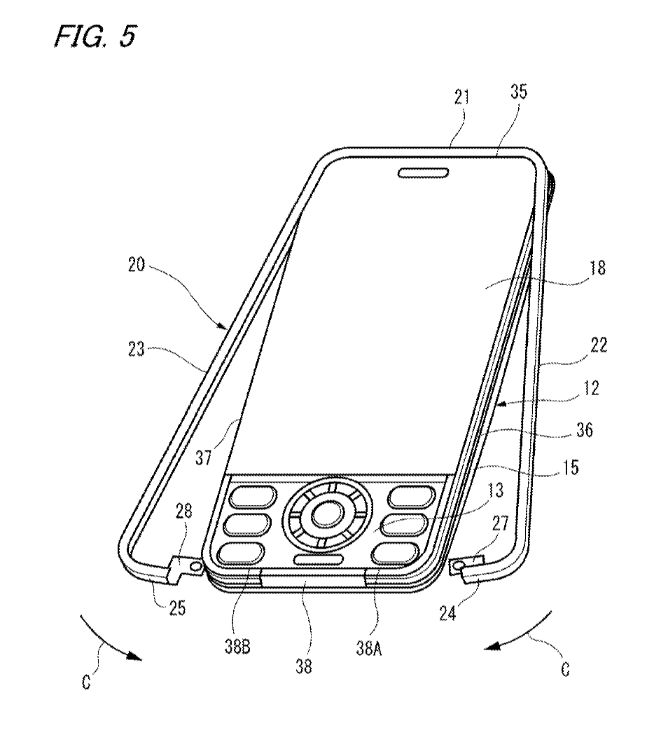

As shown in FIG. 5, the casing 12 (including the plate shaped member 18) is held by the second member 22 and the third member 23 of the fixing member 20, so that the first member 21 of the fixing member 20 is allowed to come into contact with the first side surface 35 of the case 13.

After the first member 21 is allowed to come into contact with the first side surface 35, the second member 22 of the fixing member 20 is deformed toward a direction shown by an arrow mark C and the third member 23 of the fixing member 20 is deformed toward a direction shown by an arrow mark C.

The fixing member 20 is deformed so that the second member 22 is allowed to come into contact with the second side surface 36 and the third member 23 is allowed to come into contact with the third side surface 37.

Further, the fourth member 24 comes into contact with the one part 38A of the fourth side surface 38 and the fifth member 25 comes into contact with the one part 38B of the fourth side surface 38.

As shown in FIG. 2, when the second flange 49 of the fixing member 20 is inserted to the groove part 45, the second flange 49 is engaged with the stepped surface 46.

Further, the first flange 48 is engaged with the edge part 18B of the plate shaped member 18.

Thus, the plate shaped member 18 can be fixed to the case 13 (namely, the casing 12) by the fixing member 20.

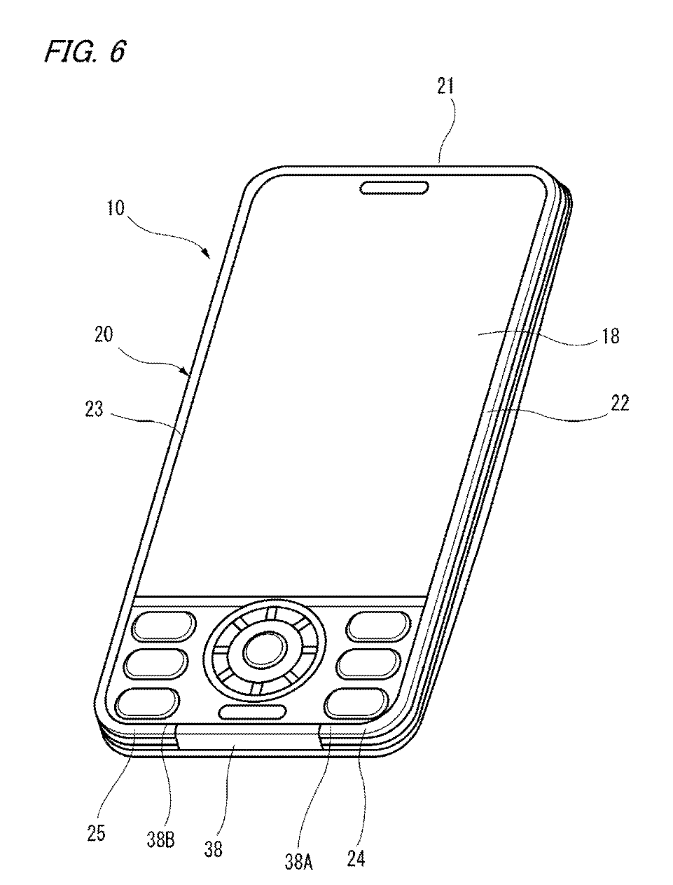

As shown in FIG. 6, the engaging piece 27 (see FIG. 5) of the fourth member 24 is engaged with the one part 38A of the fourth side surface 38 by the screw (not shown in the drawing) and the engaging screw is hidden so as not to be seen from an outer side of the casing 12.

The engaging piece 28 (see FIG. 5) of the fifth member 25 is engaged with the one part 38B of the fourth side surface 38 by the screw (not shown in the drawing) and the engaging screw is hidden so as not to be seen from an outer side of the casing.

Thus, the procedure for attaching the fixing member 20 to the casing 12 (including the plate shaped member 18) is completed.

As described above, the fixing member 20 is formed so that the dimension L1 of the space of the parting section 26 is opened large. When the fixing member 20 is attached to the casing 12, the fixing member 20 is deformed to narrow the dimension L1 of the space of the parting section 26, so that the fixing member 20 can be easily attached to the case 13.

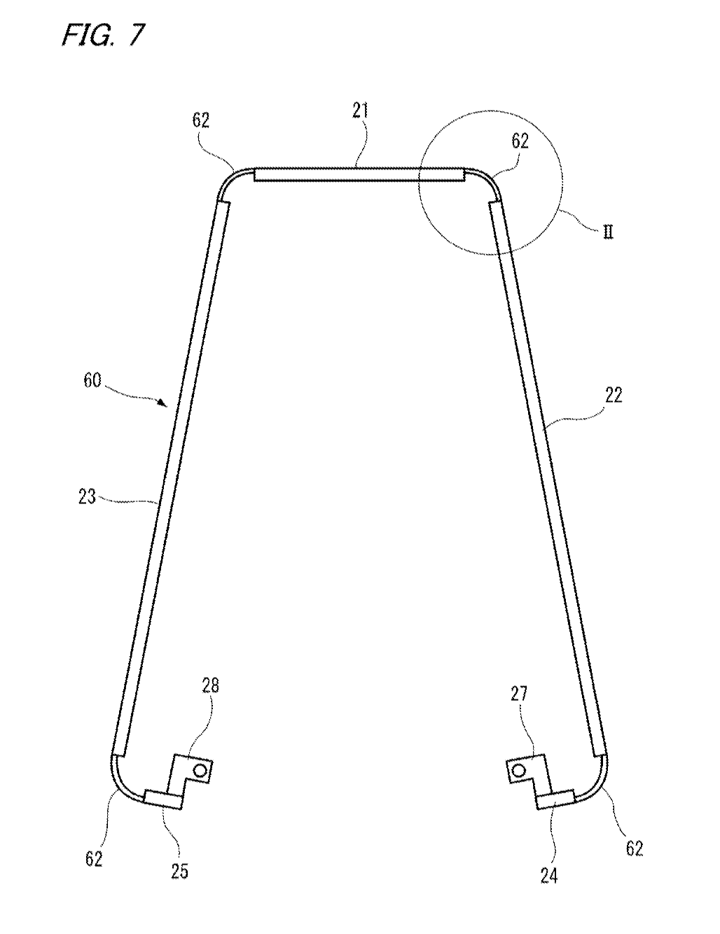

Now, a second exemplary embodiment to a fourteenth exemplary embodiment will be described below by referring to FIG. 7 to FIG. 30.

In the second exemplary embodiment to the fourteenth exemplary embodiment, the same and similar members to those of the mobile terminal 10 of the first exemplary embodiment are designated by the same reference numerals and an explanation thereof will be omitted.

### Second Exemplary Embodiment

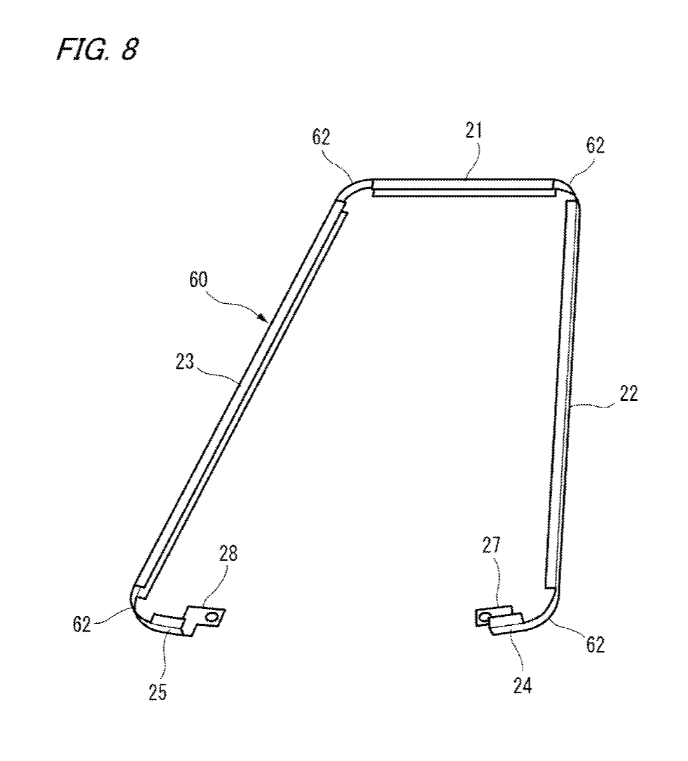

In a fixing member 60 of a second exemplary embodiment shown in FIG. 7 and FIG. 8, the bent parts 29 of the first exemplary embodiment are replaced by bent parts 62. Other structures are the same as those of the fixing member 20 of the first exemplary embodiment.

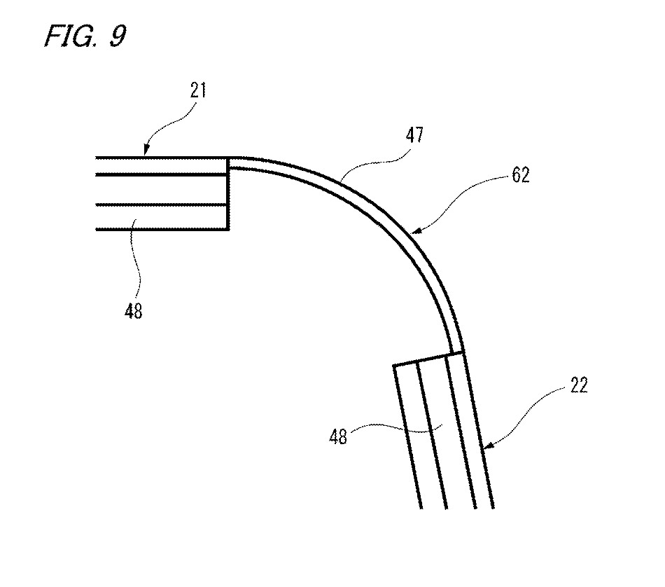

As shown in FIG. 9, the bent part 62 has only the web 47 of the first exemplary embodiment.

Namely, the bent part 62 is a part obtained by removing the first flange 48 and the second flange 49 from the bent part 29 of the first exemplary embodiment.

Since the bent part 62 is formed only by the web 47, the fixing member 60 can be easily deformed (elastically deformed).

Thus, an operation for attaching the fixing member 60 to a casing 12 can be more easily carried out.

### Third Exemplary Embodiment

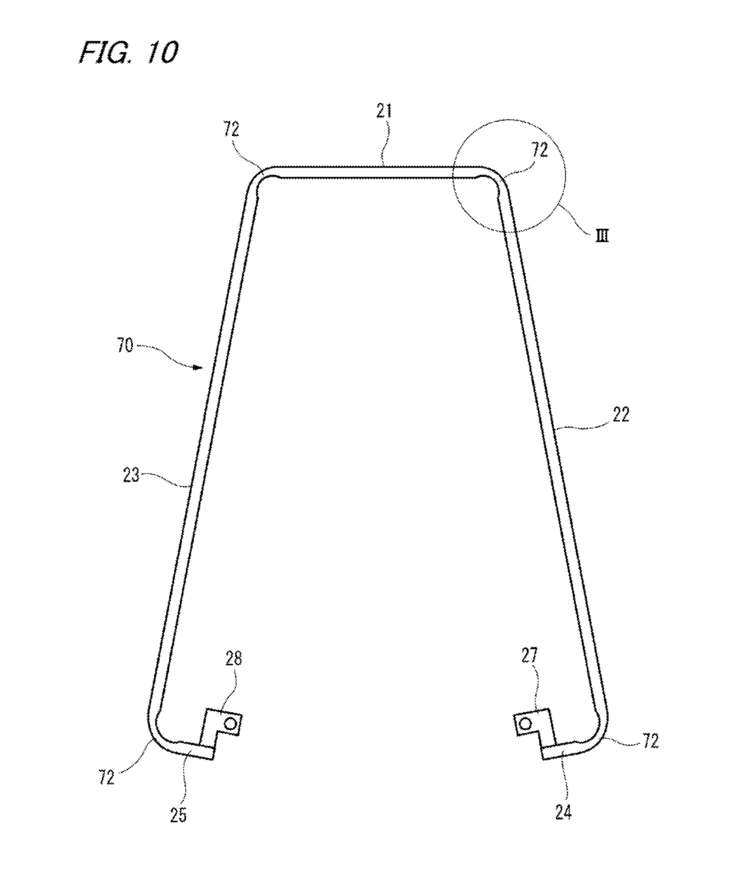

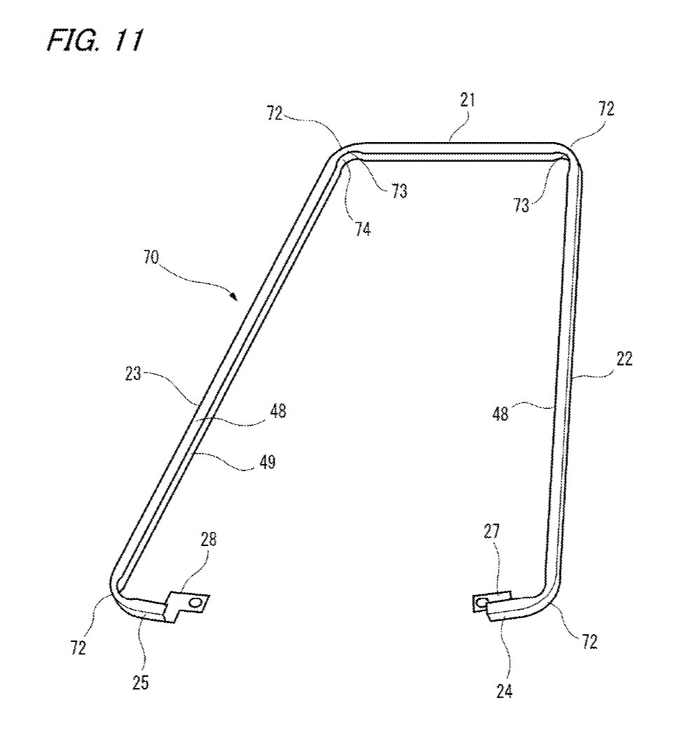

In a fixing member 70 of a third exemplary embodiment shown in FIG. 10 and FIG. 11, the bent parts 29 of the first exemplary embodiment are replaced by bent parts 72. Other structures are the same as those of the fixing member 20 of the first exemplary embodiment.

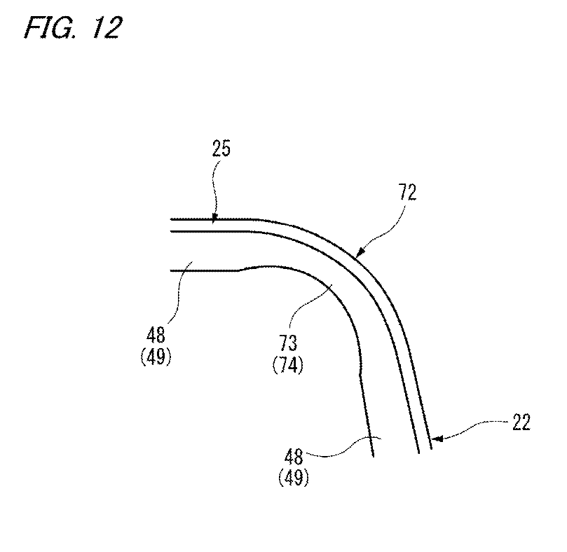

As shown in FIG. 12, the bent part 72 includes the web 47 of the first exemplary embodiment, a first flange 73 bent from an upper end of the web 47 and a second flange 74 bent from a lower end of the web 47.

Namely, in the bent part 72, the first flange 48 of the first exemplary embodiment is replaced by the first flange 73 and the second flange 49 of the first exemplary embodiment is replaced by the second flange 74.

A dimension of width of the first flange 73 is formed to be smaller than a dimension of width of the first flange 48 of the first exemplary embodiment.

Further, a dimension of width of the second flange 74 is formed to be smaller than a dimension of width of the second flange 49 of the first exemplary embodiment.

The bent part 72 is formed in the shape of C (the shape of U) in section by the web 47, the first flange 73 and the second flange 74.

Since the dimensions of width of the first flange 73 and the second flange 74 are formed to be small, the fixing member 70 can be easily deformed (elastically deformed).

Thus, an operation for attaching the fixing member 70 to a casing 12 can be more easily carried out.

Further, since the bent part 72 is provided with the first flange 73 and the second flange 74, a plate shaped member 18 can be held to a case 13 by the first flange 73 and the second flange 74.

Accordingly, the plate shaped member 18 can be more assuredly held to the case 13 than the fixing member 60 of the second exemplary embodiment.

### Fourth Exemplary Embodiment

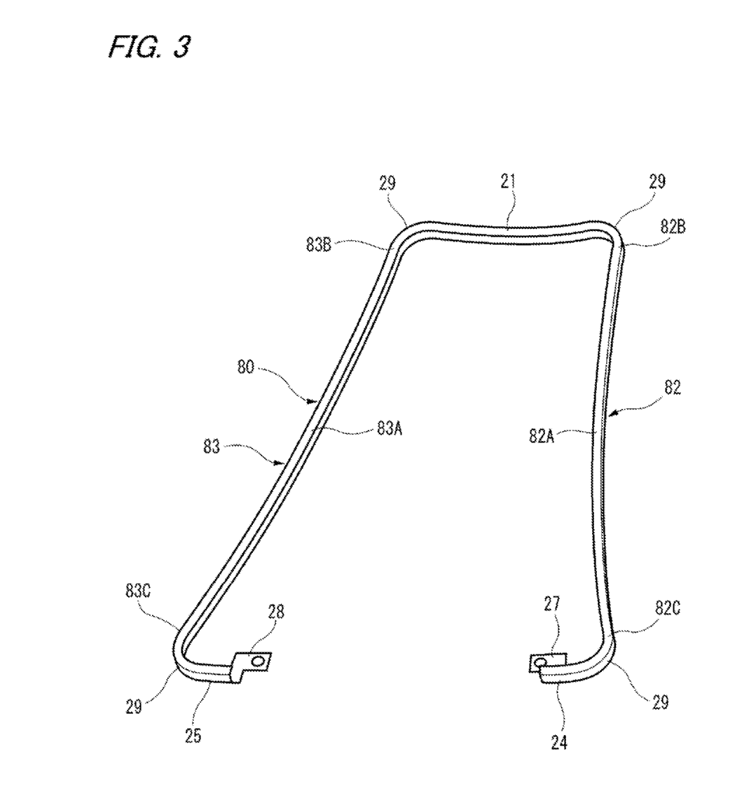

In a fixing member 80 of a fourth exemplary embodiment shown in FIG. 13, the second member 22 and the third member 23 of the first exemplary embodiment are respectively replaced by a second member 82 and a third member 83. Other structures are the same as those of the fixing member 20 of the first exemplary embodiment.

Here, the second member 22 and the third member 23 of the first exemplary embodiment are relatively long parts.

Accordingly, a central part of the second member 22 or a central part of the third member 23 is supposed to be hardly preferably pressed to the case 13.

Thus, the second member 82 and the third member 83 are formed to be bent.

Specifically, the second member 82 is formed to be bent so as to swell toward a second side surface 36 of a case 13 when the fixing member is not attached to the case, and so as to be linearly elastically deformed when the fixing member is attached thereto.

Since the second member 82 is formed to be bent, a central part 82A of the second member 82 in the longitudinal direction is formed in a planar shape so that the central part 82A is higher in its contact pressure to the case 13 (the second side surface 36) than both end parts 82B and 82C in the longitudinal direction.

The third member 83 is formed to be bent so as to swell toward a third side surface 37 of the case 13 when the fixing member is not attached to the case, and so as to be linearly elastically deformed when the fixing member is attached thereto.

Since the third member 83 is formed to be bent, a central part 83A of the third member 83 in the longitudinal direction is formed in a planar shape so that the central part 83A is higher in its contact pressure to the case 13 (the third side surface 37) than those of both end parts 83B and 83C in the longitudinal direction.

In such a way, since the contact pressures of the central part 82A of the second member 82 in the longitudinal direction is made to be high and the central part 83A of the third member 83 in the longitudinal direction is made to be high, the second member 82 can be more assuredly held on the second side surface 36 and the third member 83 can be more assuredly held on the third side surface 37.

Thus, the second member 82 and the third member 83 formed to be relatively long can be more assuredly prevented from floating.

In the first exemplary embodiment, an example is described that the contact pressure is high in the central part 82A of the second member 82 in the longitudinal direction and the central part 83A of the third member 83 in the longitudinal direction. However, the contact pressure may be made to be high only in one of the central part 82A in the longitudinal direction and the central part 83A in the longitudinal direction.

Further, the present invention also includes a form in which a first member 21 is formed to be bent.

### Fifth Exemplary Embodiment

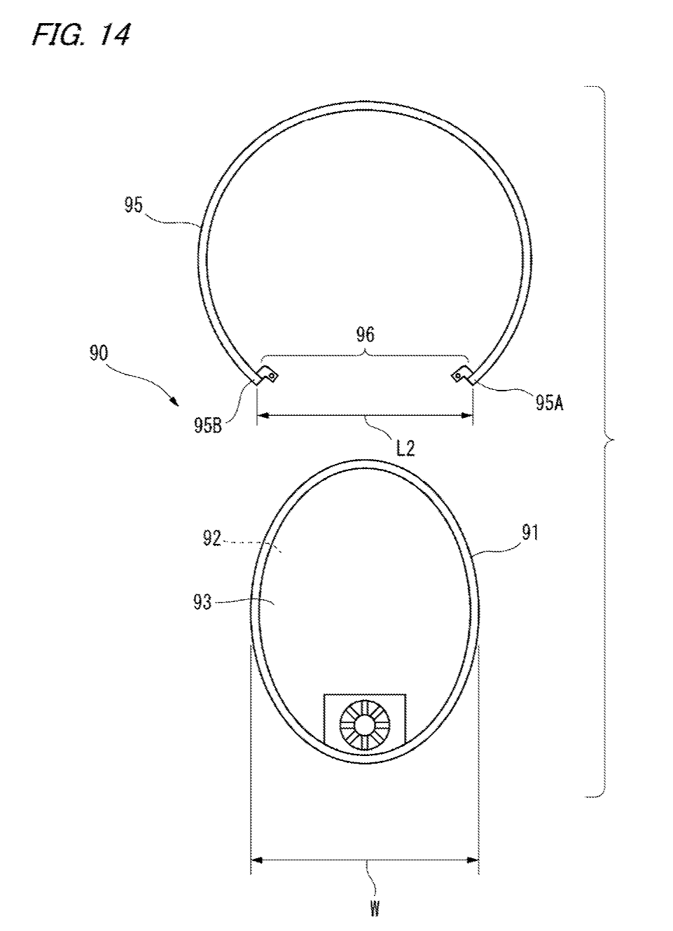

In a mobile terminal 90 of a fifth exemplary embodiment shown in FIG. 14, the casing 12, the display part 16, the plate shaped member 18 and the fixing member 20 of the first exemplary embodiment are respectively replaced by a casing 91, a display part 92, a plate shaped member 93 and a fixing member 95. Other structures are the same as those of the mobile terminal 10 of the first exemplary embodiment.

The casing 91, the display part 92 and the plate shaped member 93 are configured in an elliptic shape in a planar form.

The fixing member 95 is a substantially frame shaped member which is configured substantially in a circular shape in a planar form so as to turn around along a side surface of the casing 91 and has a parting section 96 formed between one and the other ends (one parts) 95A and 95B.

A dimension L2 of a space of the parting section 96 is opened more largely than a dimension W of width of the casing 91.

Under a state that the fixing member 95 is not attached to the casing 91, the dimension L2 of the space of the parting section 96 is opened more largely than the casing 91.

On the other hand, under a state that the fixing member 95 is attached to the casing 91, the fixing member 95 is deformed to narrow the dimension L2 of the space of the parting section 96. Thus, the fixing member 95 can be easily attached to the casing 91.

In the mobile terminal 90 of the fifth exemplary embodiment, the fixing member 95 is formed substantially in the frame shape which is turned along the side surface of the casing 91 and has the parting section 96 formed between the one end and the other end 95A and 95B. In such a way, since the fixing member 95 is turned along the side surface of the casing 91, the plate shaped member 93 can be assuredly fixed to the casing in the side surface of the casing 91.

Thus, the plate shaped member 93 can be fixed to the casing 91 only by providing the fixing member 95 as one member.

Accordingly, a structure is not necessary which uses a plurality of members to fix the plate shaped member to the casing as in the usual device and the strength differences in the vicinity of the boundaries of the plurality of members can be avoided.

Further, since the structure can be simplified, a parts cost can be reduced or assembling processes can be simplified.

Namely, according to the mobile terminal 90 of the fifth exemplary embodiment, the same effects as those of the mobile terminal 10 of the first exemplary embodiment are obtained.

In the mobile terminal 90 of the fifth exemplary embodiment, an example is described that the planar form of the casing 91 or the like is configured to be elliptic. However, the present invention is not limited thereto, and the planar form of the casing 91 or the like may be configured in other angular shape other than a rectangular shape.

### Sixth Exemplary Embodiment

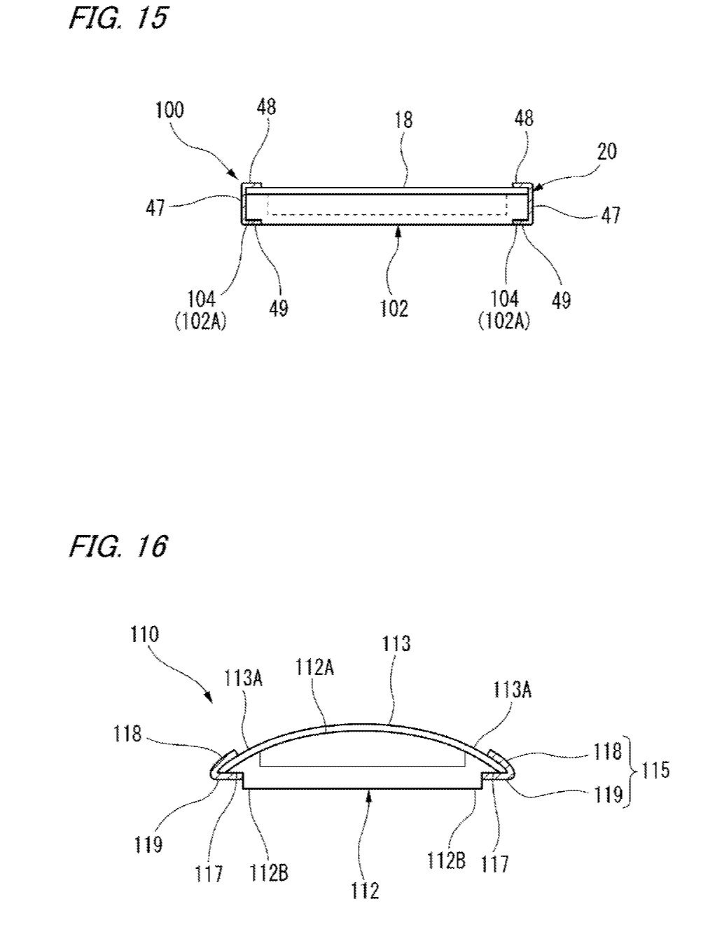

In a mobile terminal 100 of a sixth exemplary embodiment shown in FIG. 15, the stepped surface 46 of the first exemplary embodiment is replaced by a stepped surface 104 and other structures are the same as those of the mobile terminal 10 of the first exemplary embodiment.

The stepped surface 104 of the sixth exemplary embodiment is formed by recessing a peripheral edge 102A of a bottom part of a casing 102.

Namely, as for the stepped surface 46 of the first exemplary embodiment, an example is described that the stepped surface is formed by using the groove part 45 of the case 13. However, the stepped surface 104 of the sixth exemplary embodiment is formed in the peripheral edge 102A of the bottom part of the casing 102 in place thereof.

When a second flange 49 of a fixing member 20 is engaged with the stepped surface 104, a plate shaped member 18 can be attached to the casing 102 by the fixing member 20 as in the first exemplary embodiment.

### Seventh Exemplary Embodiment

In a mobile terminal 110 of a seventh exemplary embodiment shown in FIG. 16, the casing 12, the plate shaped member 18 and the fixing member 20 of the first exemplary embodiment are respectively replaced by a casing 112, a plate shaped member 113 and a fixing member 115. Other structures are the same as those of the mobile terminal 10 of the first exemplary embodiment.

The casing 112 has a surface 112A formed to be bent and a stepped surface 117 formed in a peripheral edge 112B of a bottom part.

The plate shaped member 113 is formed to be bent so as to be mounted along the surface 112A of the casing 112.

The fixing member 115 is formed substantially in the shape of V in section by a first flange 118 and a second flange 119.

In the fixing member 105, the second flange 119 is engaged with the stepped surface 117 and the first flange 118 is engaged with an edge part 113A of the plate shaped member 113.

Since the second flange 119 is engaged with the stepped surface 117 and the first flange 118 is engaged with the edge part 113A of the plate shaped member 113, the plate shaped member 113 can be fixed to the casing 112 by the fixing member 115 as in the mobile terminal 10 of the first exemplary embodiment.

### Eighth Exemplary Embodiment

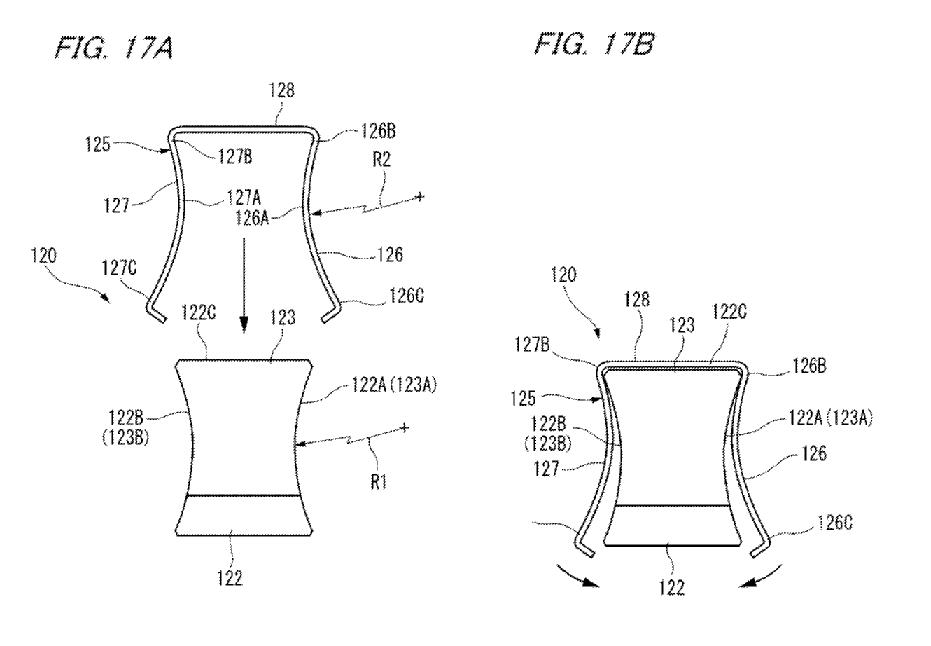

In a mobile terminal 120 of an eighth exemplary embodiment shown in FIG. 17A and FIG. 17B, the casing 12, the plate shaped member 18 and the fixing member 20 of the first exemplary embodiment are respectively replaced by a casing 122, a plate shaped member 123 and a fixing member 125. Other structures are the same as those of the mobile terminal 10 of the first exemplary embodiment.

In the casing 122, a second side surface 122A and a third side surface 122B are bent to be recessed with a radius R1. Other forms are the same as those of the casing 12 of the first exemplary embodiment.

In the plate shaped member 123, edge parts 123A and 123B corresponding to the second side surface 122A and the third side surface 122B of the casing 122 are bent to be recessed with a radius R1 like the casing 122.

In the fixing member 125, a second member 126 and a third member 127 are bent to be recessed with a radius R2. Other forms are the same as those of the fixing member 20 of the first exemplary embodiment.

The radius R2 of the second member 126 and the third member 127 is formed to be smaller than the radius R1 of the second side surface 122A and the third side surface 122B.

Accordingly, a central part 126A of the second member 126 in the longitudinal direction is formed in a planar shape so as to be higher in its contact pressure to the casing 122 (the second side surface 122A) than both end parts 126B and 1260 in the longitudinal direction.

Further, a central part 127A of the third member 127 in the longitudinal direction is formed in a planar shape so as to be higher in its contact pressure to the casing 122 (the third side surface 122B) than both end parts 127B and 127C in the longitudinal direction.

As described above, since the contact pressure of the central part 126A of the second member 126 in the longitudinal direction is made to be high and the contact pressure of the central part 127A of the third member 127 in the longitudinal direction is made to be high, the second member 126 can be more assuredly held on the second side surface 122A and the third member 127 can be more assuredly held on the third side surface 122B.

Thus, the second member 126 and the third member 127 formed to be relatively long can be more assuredly prevented from floating.

A form is also included in the present invention in which a first side surface 122C of the casing 122 is bent to be recessed and a first member 128 of the fixing member 20 is formed to be bent.

### Modified Example of Eighth Exemplary Embodiment

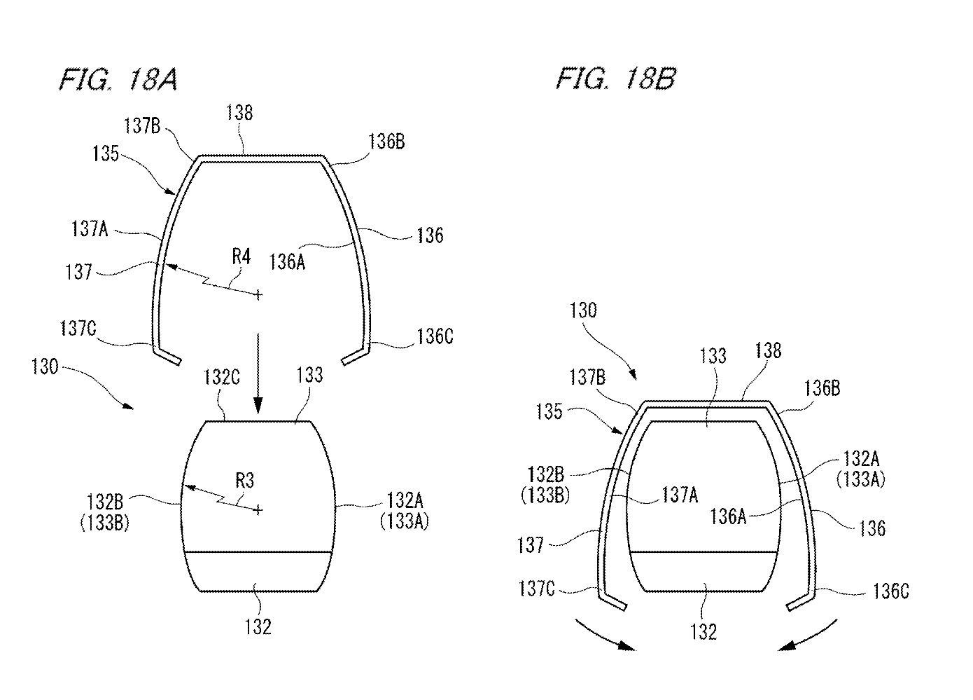

In a mobile terminal 130 of a modified example shown in FIG. 18A and FIG. 18B, the casing 122, the plate shaped member 123 and the fixing member 125 of the eighth exemplary embodiment are respectively replaced by a casing 132, a plate shaped member 133 and a fixing member 135. Other structures are the same as those of the mobile terminal 120 of the eighth exemplary embodiment.

In the casing 132, a second side surface 132A and a third side surface 132B are bent to protrude with a radius R3. Other forms are the same as those of the casing 122 of the eighth exemplary embodiment.

In the plate shaped member 133, edge parts 133A and 133B corresponding to the second side surface 132A and the third side surface 132B of the casing 132 are bent to protrude with a radius R3 like the casing 132.

In the fixing member 135, a second member 136 and a third member 137 are bent to protrude with a radius R4. Other forms are the same as those of the fixing member 125 of the eighth exemplary embodiment.

The radius R4 of the second member 136 and the third member 137 is formed to be larger than the radius R3 of the second side surface 132A and the third side surface 132B.

Accordingly, a central part 136A of the second member 136 in the longitudinal direction is formed in a planar shape so as be higher in its contact pressure to the casing 132 (the second side surface 132A) than both end parts 136B and 136C in the longitudinal direction.

Further, a central part 137A of the third member 137 in the longitudinal direction is formed in a planar shape so as to be higher in its contact pressure to the casing 132 (the third side surface 132B) than both end parts 137B and 137C in the longitudinal direction.

As described above, since the contact pressure of the central part 136A of the second member 136 in the longitudinal direction is made to be high and the contact pressure of the central part 137A of the third member 137 in the longitudinal direction is made to be high, the second member 136 can be more assuredly held on the second side surface 132A and the third member 137 can be more assuredly held on the third side surface 132B.

Thus, the second member 136 and the third member 137 formed to be relatively long can be more assuredly prevented from floating as in the mobile terminal 120 of the eighth exemplary embodiment.

A form is also included in the present invention in which a first side surface 132C of the casing 132 is bent to be recessed and a first member 138 of the fixing member 135 is formed to be bent.

### Ninth Exemplary Embodiment

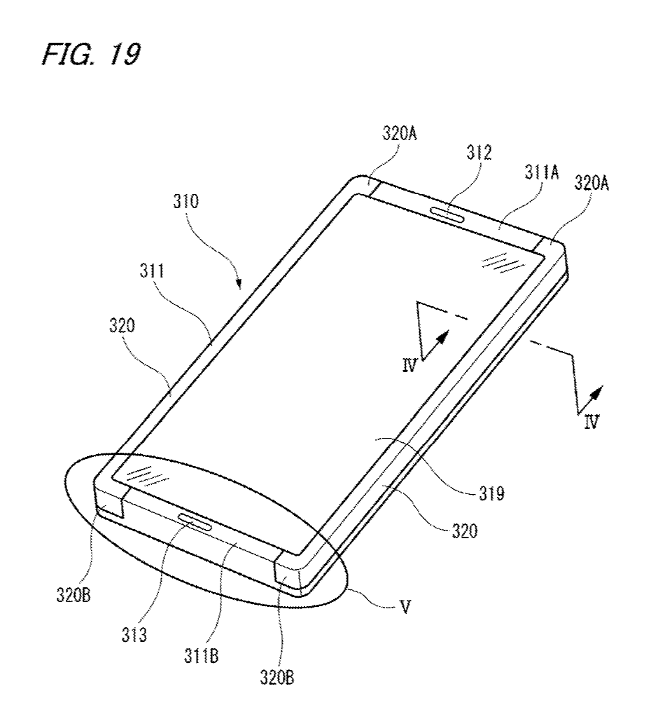

As shown in FIG. 19, a mobile terminal 310 includes a casing 311 of a substantially rectangular form in a plane with a prescribed thickness, a receiving part 312 for speaking or communication provided in an upper end part 311A of the casing 311 and a transmitting part 313 for speaking or communication provided in a lower end part 311B of the casing 311.

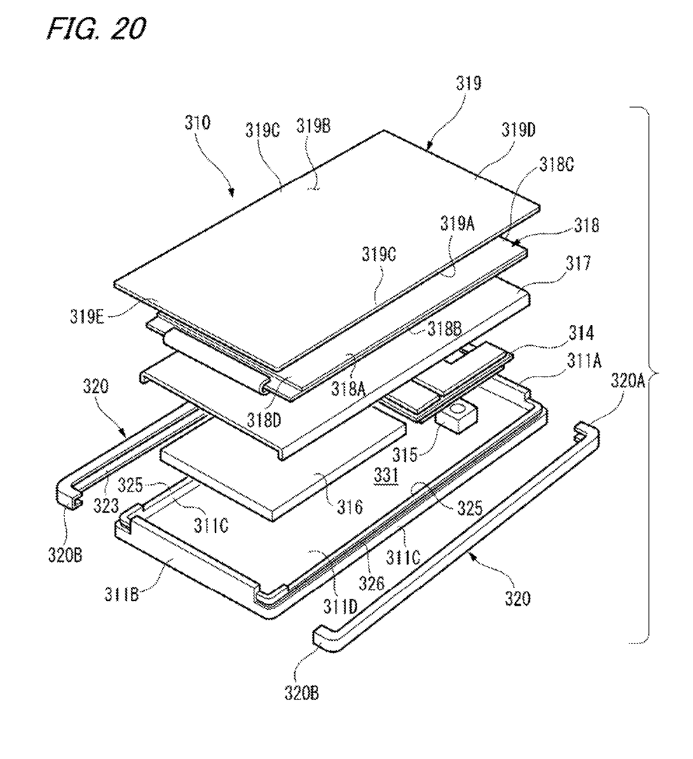

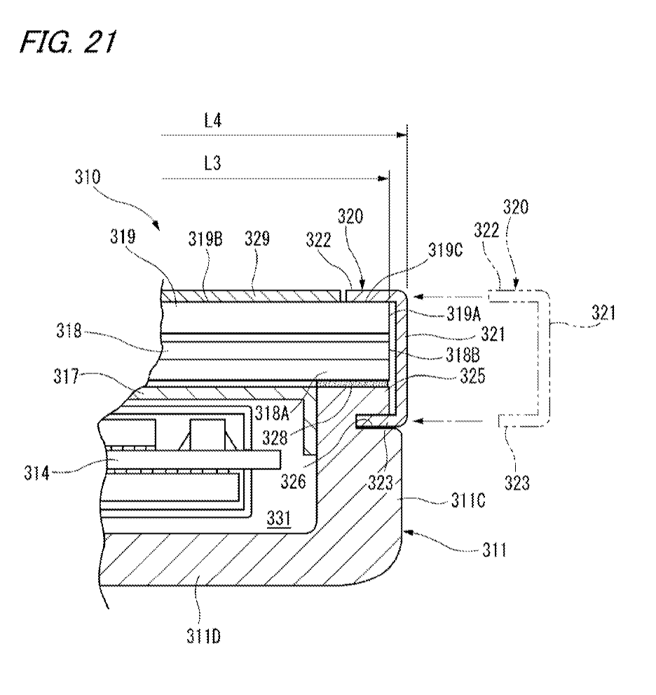

Further, as shown in FIG. 20, the mobile terminal 310 includes a circuit board 314 and a camera device 315 accommodated in an upper half part of an accommodating part 331 of the casing 311, a battery 316 accommodated in a lower half part of the accommodating part 331 of the casing 311 and a chassis 317 supported by the casing 311.

Further, the mobile terminal 310 includes a display device 318 supported by the chassis 317, a protecting panel 319 laminated on the display device 318 and one pair of support members 320 which fix the display device 318 and the protecting panel 319 to the casing 311.

In the casing 311, in side walls of both sides (side surfaces of the casing 311) 3110, stepped parts 325 are formed. On outer surfaces of the side walls 3110, groove parts (stepped surfaces) 326 (see also FIG. 21) are formed.

The groove parts 326 are formed along a bottom part 311D of the casing 311 in the outer surfaces of the side walls 3110. Third members 323 of the support members 320 are inserted into the groove parts 326 (see also FIG. 21) so that third members 323 are engaged with the groove parts 326.

The chassis 317 is configured substantially in a rectangular form in plan view and supported by the casing 311 in such an arranged state as to cover the circuit board 314, the camera device 315 and the battery 316.

As shown in FIG. 21, the display device 318 is formed substantially in a rectangular shape by an organic EL or a liquid crystal. Both sides 318A (only one side 318A is shown in the drawing) are stuck to the stepped parts 325 of the casing 311 through double-sided tapes 328.

The protecting panel 319 is configured substantially in a rectangular form (see FIG. 20). Both side surfaces 319A (refer them to as “protecting end faces”, hereinafter) are formed so as to be substantially flush with both surfaces 318B (refer them to as “display end faces”, hereinafter) of the display device 318.

Namely, the display end faces 318B and the protecting end faces 319A are mutually formed so as to be extended along the same surface.

Accordingly, the display device 318 having the substantially same dimension L3 (specifically, a dimension in a direction of width) as that of the protecting panel 319 can be used, so that the display device 318 of a large size can be used.

As shown in FIG. 20, an upper end face 318C of the display device 318 is formed so as to be stepped relative to an upper end face 319D of the protecting panel 319. Namely, the upper end face 319D of the protecting panel 319 and the upper end face 318C of the display device 318 are not formed in the same surface.

Similarly, a lower end face 318D of the display device 318 is provided so as to be stepped relative to a lower end face 319E of the protecting panel 319. Namely, the lower end face 319E of the protecting panel 319 and the lower end face 318D of the display device 318 are not formed in the same surface.

The display device 318 and the protecting panel 319 are fixed to the casing 311 by the support members 320.

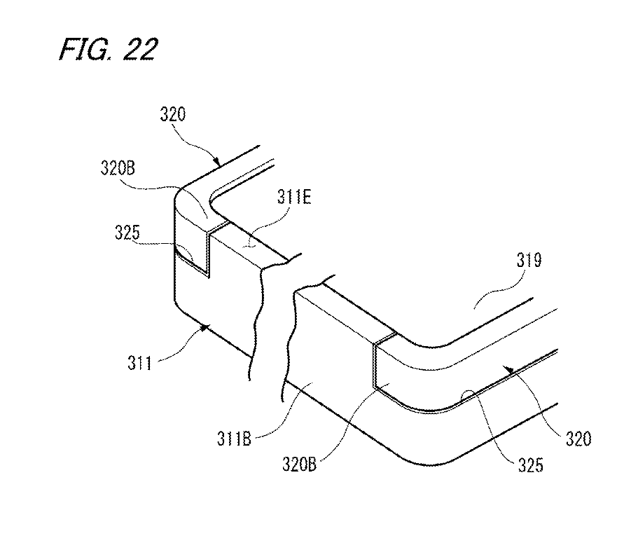

As shown in FIG. 20 and FIG. 22, the support member 320 is a member made of metal and arranged in the stepped part 325 of the casing 311.

In the support member 320, an upper end part 320A is bent along the upper end part 311A of the casing 311 and a lower end part 320B is bent along the lower end part 311B of the casing 311 (see also FIG. 19).

When he upper end part 320A of the support member 320 is bent along the upper end part 311A of the casing 311 and the lower end part 320B of the support member 320 is bent along the lower end part 311B of the casing 311, the strength of the support member 320 can be sufficiently ensured.

As shown in FIG. 21, the support member 320 includes a first member 321 arranged in parallel with the display end face 318B and the protecting end face 319A, a second member 322 connected to the first member 321 and a third member 323 provided in an opposite side to the second member 322 in the first member 321.

The second member 322 and the third member 323 are bent substantially in parallel with each other, so that the support member 320 is formed substantially in the shape of U by the first member 321.

the second member 322 and the third member 323.

The first member 321 is a member that is arranged in parallel along the display end face 318B and the protecting end face 319A to cover the display end face 318B and the protecting end face 319A.

Here, since the display end face 318B and the protecting end face 319A are mutually formed so as to extend along the same surface, the display end face 318B can be arranged so as to be adjacent to the first member 321.

Further, the first member 321 is arranged so as to be flush with the side wall 311C of the casing 311.

Accordingly, a maximum dimension L3 of the display device 318 can be set substantially to the same form as a dimension L4 of an outer form of the casing 311.

The second member 322 is a member which covers an edge part 3190 in a surface 319B of the protecting panel 319 and is arranged so as to be substantially flush with a surface 311E of the casing 311 (see FIG. 22).

Since the surface 319B (the edge part 319C) of the protecting panel 319 is covered with the second member 322, the second member 322 is formed to be stepped relative to the surface 319B of the protecting panel 319.

Here, the support member 320 is formed with the metal. Accordingly, since the strength of the support member 320 can be improved, a dimension T of thickness of the support member 320 can be reduced.

Thus, a step formed by the surface 319B of the protecting panel 319 and the second member 322 can be made to be small.

A sheet 329 may be laminated on the surface 319B of the protecting panel 319.

In such a way, when the sheet 329 is laminated on the surface 319B of the protecting panel 319 the step formed on the surface 319B of the protecting panel 319 by the support member 320 can be eliminated or the step can be decreased.

The third member 323 is a member which is engaged with the groove part 326 so as to be fixed to the casing 311.

The third member 323 is engaged with the groove part 326 and thus fixed to the casing 311. The second member 322 covers the edge part 319C in the surface 319B of the protecting panel 319 so that the display device 318 and the protecting panel 319 are fixed together to the casing 311 by the support member 320.

As described above, when the protecting panel 319 is laminated on the display device 318, the display device 318 having the substantially same dimension L3 (specifically, the dimension in the direction of width) as that of the protecting panel 319 can be used.

Further, the display end face 318B can be arranged so as to be adjacent to the first member 321 and the first member 321 can be arranged so as to be flush with the side wall 311C of the casing 311.

Thus, since the maximum dimension L3 of the display device 318 can be set substantially to the same form as the dimension L4 of the outer form of the casing 311 the display device 318 of a large size can be used.

Especially, since the third member 323 of the support member 320 is engaged with the groove part 326 of the casing 311 so that the support member is fixed to the casing 311, the display device 318 and the protecting panel 319 can be assuredly fixed to the casing 311 by the support member 320.

### Tenth Exemplary Embodiment

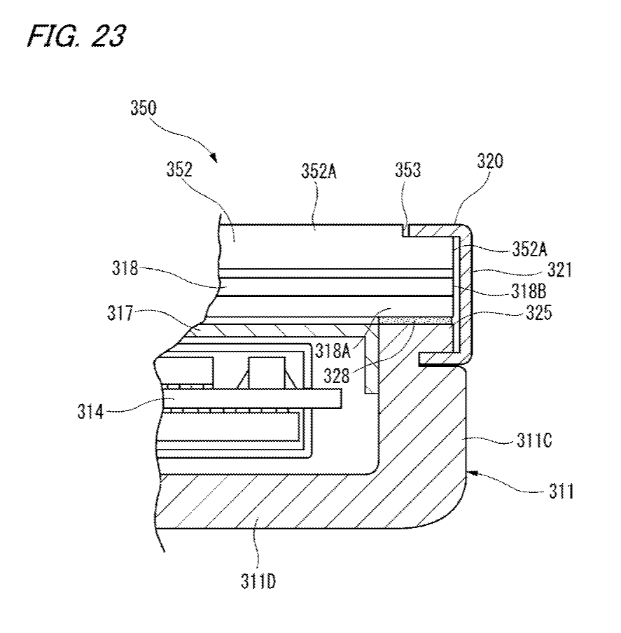

In a mobile terminal 350 of a tenth exemplary embodiment shown in FIG. 23, the protecting panel 319 of the ninth exemplary embodiment is replaced by a protecting panel 352. Other structures are the same as those of the mobile terminal 310 of the ninth exemplary embodiment.

In the protecting panel 352, a stepped part 353 is formed along a protecting end face 352A of a surface 352B. Other structures are the same as those of the protecting panel 319 of the ninth exemplary embodiment.

When the protecting panel 352 is formed with glass, the stepped part 353 of the protecting panel 352 is formed by a cutting work. When the protecting panel 352 is made of a resin, the stepped part is integrally formed or formed by a cutting work.

As described above, when the stepped part 353 is formed along the protecting end face 352A of the surface 352B, a step formed on the surface 352B of the protecting panel 352 by a support member 320 can be eliminated or a step can be decreased.

The protecting end face 352A and a display end face 318B are mutually formed so as to be extended along the same surface like the ninth exemplary embodiment.

### Eleventh Exemplary Embodiment

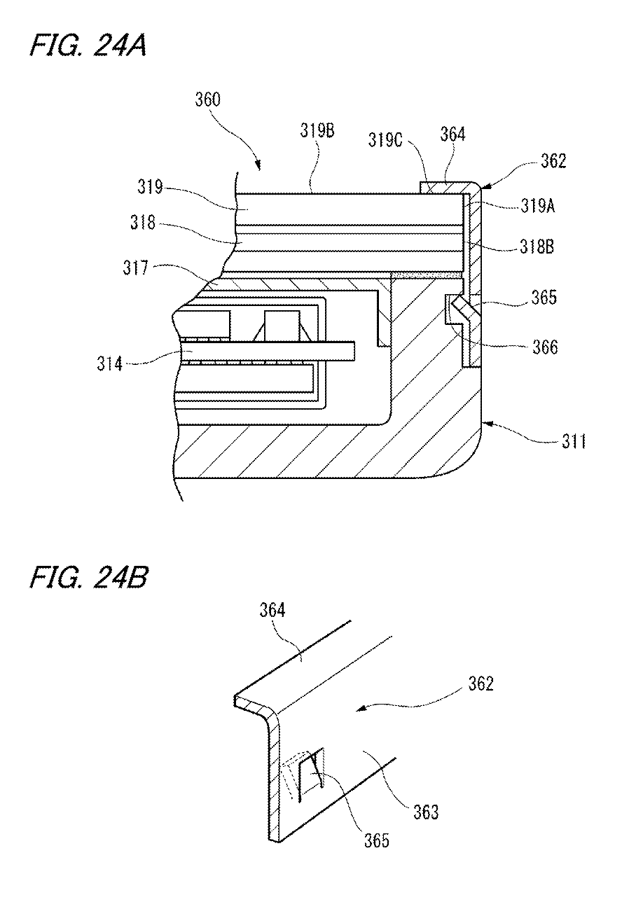

In a mobile terminal 360 of an eleventh exemplary embodiment shown in FIGS. 24A and 24B, the support member 320 of the ninth exemplary embodiment is replaced by a support member 362. Other structures are the same as those of the mobile terminal 310 of the ninth exemplary embodiment.

The support member 362 includes a first member 363 arranged in parallel with a display end face 318B and a protecting end face 319A, a second member 364 connected to the first member 363 and a third member 365 provided in an opposite side to the second member 364 in the first member 363.

The second member 364 is bent so that the support member 362 is formed substantially in the shape of L in section by the first member 363 and the second member 364.

The first member 363 is a member that covers the display end face 318B and the protecting end face 319A like the first member 321 of the ninth exemplary embodiment.

The second member 364 is a member which covers an edge part 319C in a surface 319B of a protecting panel 319 like the second member 322 of the ninth exemplary embodiment.

A plurality of third members 365 are formed at prescribed intervals along a groove part 366 and bent toward the groove part 366 so as to be engaged with the groove part 366.

When the third member 365 is engaged with the groove part 366, the third member 365 is fixed to a casing 311. The second member 364 covers the edge part 3190 in the surface 319B of the protecting panel 319. Thus, a display device 318 and the protecting panel 319 are fixed together to the casing 311 by the support member 362.

Thus, the display device 318 of a large size can be used as in the ninth exemplary embodiment.

### Twelfth Exemplary Embodiment

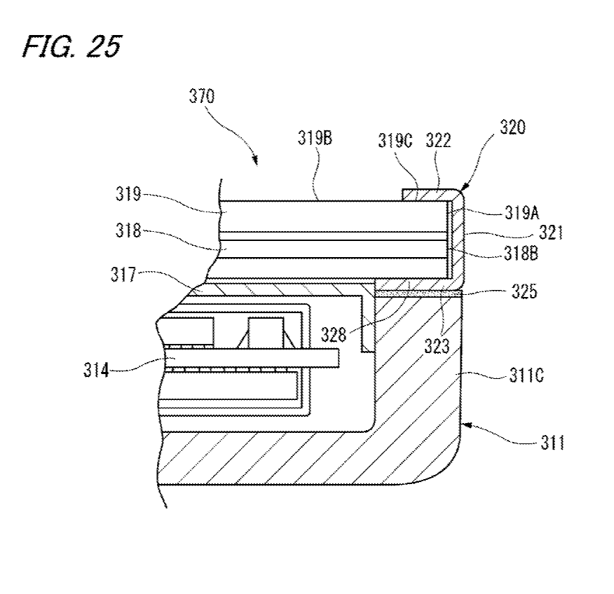

In a mobile terminal 370 of a twelfth exemplary embodiment shown in FIG. 25, the third member 323 of the support member 320 of the ninth exemplary embodiment is stuck to a double-sided tape 328. Other structures are the same as those of the mobile terminal 310 of the ninth exemplary embodiment.

The third member 323 can be fixed to a stepped part 325 of a casing 311 through the double-sided tape 328.

Accordingly, under a state that an edge part 319C in a surface 319B of a protecting panel 319 is covered with a second member 322, a display device 318 and the protecting panel 319 are fixed together to the casing 311 by the support member 320. Thus, the display device 318 of a large size can be used like the ninth exemplary embodiment.

Further, since a groove part 326 can be removed from a side wall 311C of the casing 311, a form of the casing 311 can be simplified.

### Thirteenth Exemplary Embodiment

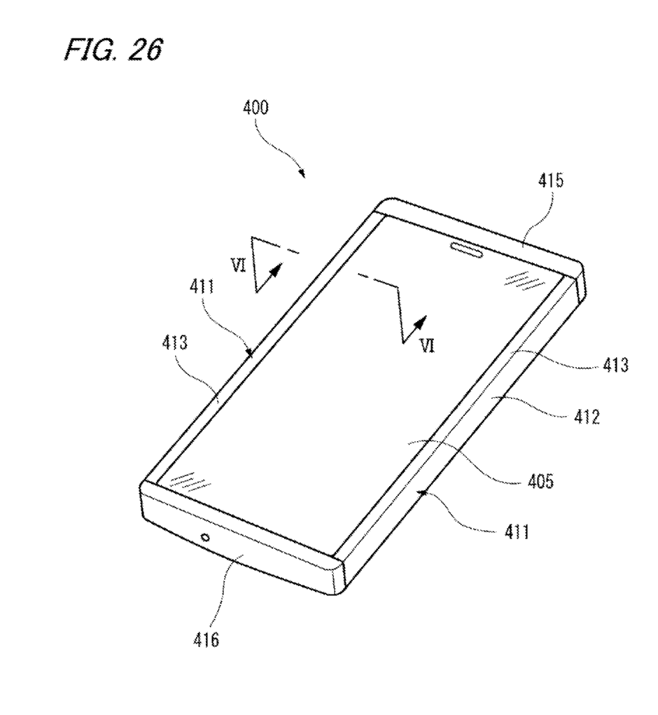

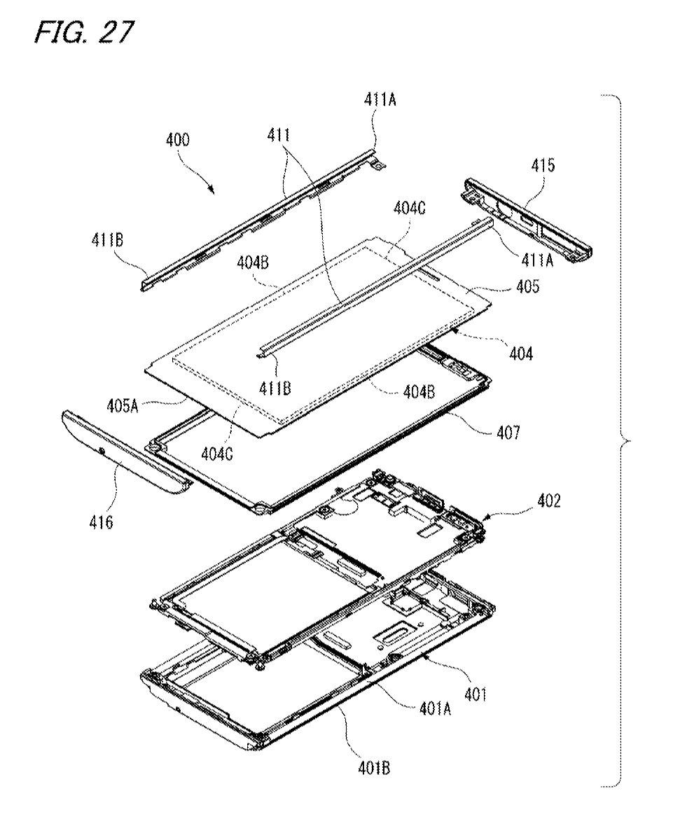

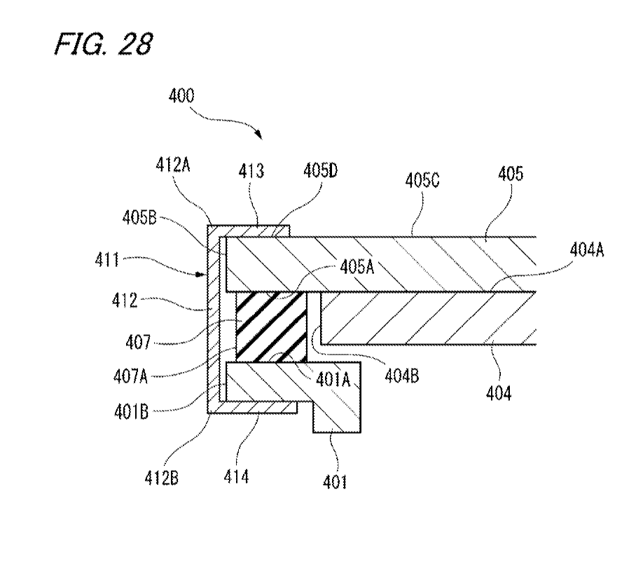

A mobile terminal 400 of a thirteenth exemplary embodiment shown in FIG. 26 and FIG. 27 includes a casing 401, a board unit 402 accommodated in the casing 401, a display device 404 accommodated in the casing 401 and a protecting panel 405 laminated on a front side 404A (see FIG. 28) of the display device 404.

Further, the mobile terminal 400 includes an elastic member 407 interposed between the casing 401 and the protecting panel 405 and one pair of support members 411 for fixing the protecting panel 405 to the casing 401.

In addition thereto, the mobile terminal 400 includes a first frame 415 made of a resin which supports one end parts 411A of the one pair of support members 411 and a second frame 416 made of a resin which supports the other end parts 411B of the one pair of support members 411.

The elastic member 407 is formed substantially in a rectangular frame shape so as to cover both side surfaces 404B or both end parts 404C of the display device 404.

As shown in FIG. 28, the elastic member 407 is interposed between a peripheral part 401A (see also FIG. 27) of the casing 401 and a peripheral part 405A (see FIG. 27) of the protecting panel 405.

A space between the casing 401 and the protecting panel 405 can be sealed by the elastic member 407 and a water-tightness of the display device can be ensured.

The support member 411 is a metal frame as a member made of metal which is formed in the shape of U in section by a first member 412, a second member 413 and a third member 414.

The first member 412 is a member which faces a side surface 405B of the protecting panel 405, a side surface 407A of the elastic member 407 and a side surface 401B of the casing 401.

The second member 413 is a member which is bent toward the protecting panel 405 from an upper side 412A of the first member 412 to cover an edge part 405D in a surface 405C of the protecting panel 405.

The third member 414 is a member which is bent toward the casing 401 from a lower side 412B of the first member 412, that is, an opposite side to the second member 413 in the first member 412.

The side surfaces 404B of the display device 404 are covered with the elastic member 407 and the elastic member 407 is interposed between the casing 401 and the protecting panel 405.

Thus, since a seal material (for instance, a double-sided tape) can be removed between the display device 404 and the casing 401 or between the protecting panel 405 and the casing 401, the thickness of the mobile terminal 400 can be reduced.

Further, since the second member 413 can be provided in a position corresponding to the elastic member 407, the second member 413 can be allowed to come near the side surface 405B of the protecting panel 405.

Thus, since a dimension of width of the second member 413 can be reduced, a screen of the display device 404 can be enlarged relative to a plane area of the mobile terminal 400.

Since the support member 411 is configured in the form of the metal frame of a U shape in section, a rigidity of the support member 411 can be improved. Thus, since the dimension of width of the second member 413 can be suppressed to be small, the mobile terminal 10 can be miniaturized.

Further, since the support member 411 is configured in the form of the metal frame of a U shape in section, the protecting panel 405 can be assuredly fixed to the casing 401 by the support member 411. Further, both the side surfaces 405B of the protecting panel 405 or both the side surfaces 401B of the casing 401 can be protected by the support members 411.

In addition thereto, the second member 413 of the support member 411 is turned toward the edge part 405D in the surface 405C of the protecting panel 405, so that a step is formed in the edge part 405D of the protecting panel 405. Accordingly, the belly of the palm can be supported by the second member 413 so that the belly of the palm does not come into contact with the protecting panel 405. Thus, an erroneous operation can be prevented.

Further, since the second member 413 forms the step in the edge part 405D of the protecting panel 405, the belly of a finger is allowed to come into contact with the step so that a user may recognize that the finger is located in an end part of the mobile terminal 400.

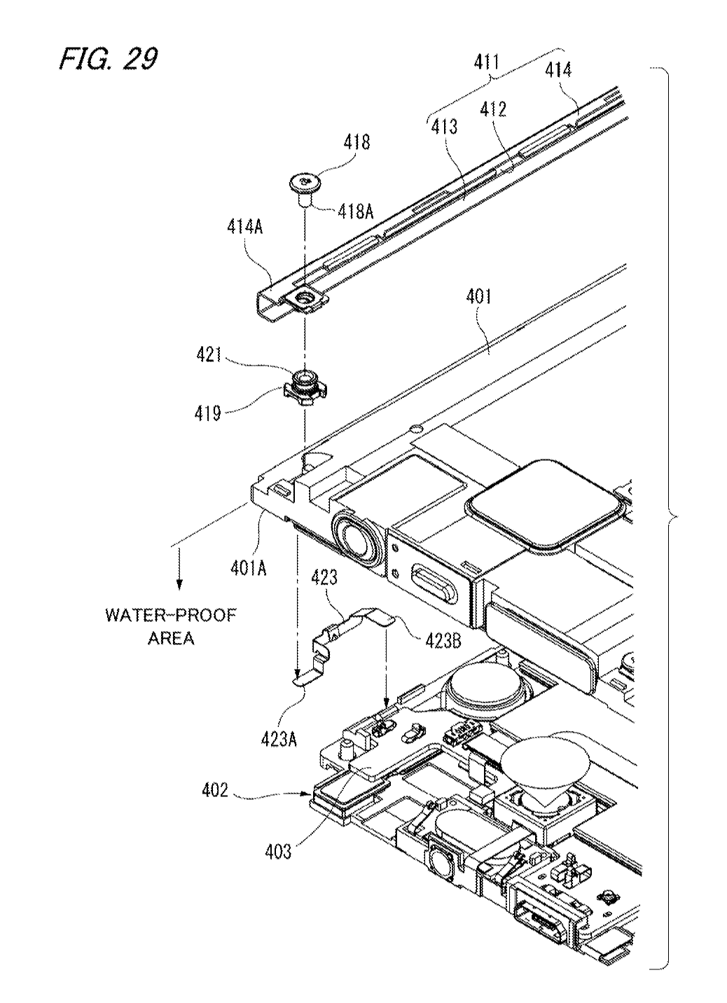

As shown in FIG. 29, an end part 414A of the third member 414 is fixed to the casing 401 by a screw 418 and a nut 419. An 0 ring 421 is interposed between the screw 418 and the nut 419. A range in a direction shown by an arrow mark from the peripheral part 401A (see also FIG. 28) of the casing 401 is set as a water-proof area.

Further, under a state that the end part 414A of the third member 414 is fixed to the casing 401 by the screw 418, an end part 418A of the screw 418 is allowed to come into contact with one end part 423A of a ground member 423.

The ground member 423 is formed with a thin plate and has one end part 423A allowed to come into contact with the end part 418A of the screw 418 and the other end part 423B allowed to come into contact with a circuit board 403 of the board unit 402.

Accordingly, since the support member 411 is electrically connected to the circuit board 403 of the board unit 402 through the screw 418 and the ground member 423, an influence to an antenna property can be reduced.

Further, for instance, a static electricity is applied, the support member 411 can be utilized as a lightening rod and an abnormality of an operation of the display device 404 (see FIG. 28) can be prevented from occurring.

### Fourteenth Exemplary Embodiment

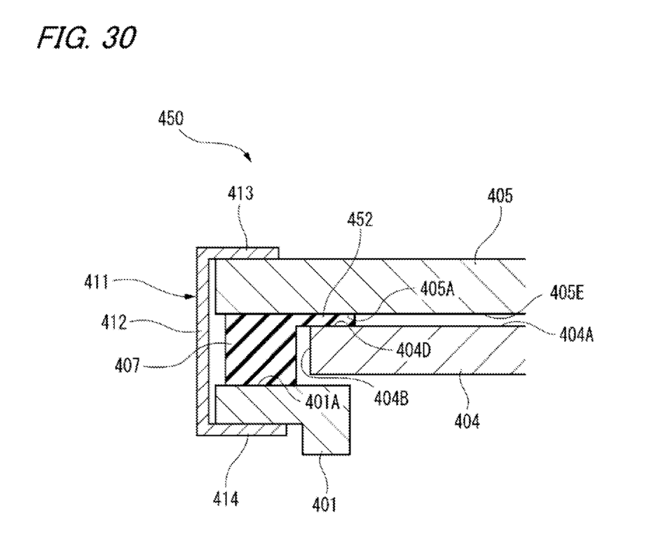

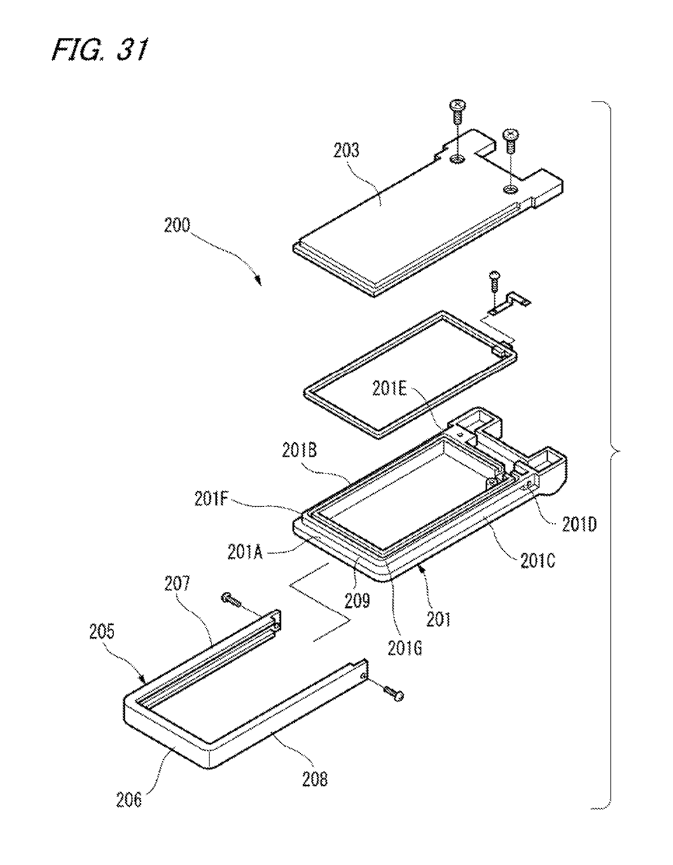

A mobile terminal 450 of a fourteenth exemplary embodiment shown in FIG. 30 has a belt part 452 connected to an elastic member 407. Other structures are the same as those of the mobile terminal 400 of the thirteenth exemplary embodiment.

The belt part 452 is connected to the elastic member 407 and interposed between a display device 404 and a protecting panel 405.

Specifically, the belt part 452 is formed in the shape of a rectangular frame and interposed between all periphery of a peripheral part 404D of a display device 404 (a front side 404A) and all periphery of a peripheral part 405A of a protecting panel 405 (a back side 405E).

Thus, a gap between the display device 404 and the protecting panel 405 can be sealed by the belt part 452 to more improve a dust-proof performance between the display device 404 and the protecting panel 405.

The mobile terminal according to the present invention is not limited to the above-described exemplary embodiments respectively and may be suitably modified and improved.

For instance, in the first exemplary embodiment to the eighth exemplary embodiment, an initial form of the fixing member shows that the legs are opened, however, the initial form may correspond to a planar form of the casing and the parting section may be deformed to be opened in an attaching operation.

Further, the forms or the structures of the mobile terminals, the casings, the display parts, the plate shaped members, the fixing members, the first members to the fifth members, the bent parts, the first side surfaces to the fourth side surfaces, the planar angular parts, the mounting surfaces and the stepped surfaces used in the first exemplary embodiment to the eighth exemplary embodiment are not limited to the exemplified forms or structures and may be suitably changed.

For instance, in the ninth exemplary embodiment to the twelfth exemplary embodiment, the example is described in which the upper end face 318C of the display device 318 is provided so as to be stepped relative to the upper end face 319D of the protecting panel 319. The lower end face 318D of the display device 318 is provided so as to be stepped relative to the lower end face 319E of the protecting panel 319. However, the present invention is not limited thereto.

For instance, the upper end face 319D of the protecting panel 319 and the upper end face 3180 may be formed on the same plane and the lower end face 319E of the protecting panel 319 and the lower end face 318D of the display device 318 may be formed on the same plane.

Further, in the ninth exemplary embodiment to the twelfth exemplary embodiment, the example is described in which the display end face 318B of the display device 318 and the protecting end face 319A of the protecting panel 319 are mutually formed so as to be extended along the same surface. However, the present invention is not limited thereto and the display end face 318A and the protecting panel 319A may be formed stepped to each other.

Further, the forms or the structures of the mobile terminals, the casings, the display devices, the protecting panels, the support members and the sheets used in the ninth exemplary embodiment to the twelfth exemplary embodiment are not limited to the exemplified forms or structures and may be suitably changed.

Further, the forms or the structures of the mobile terminals, the casings, the display devices, the protecting panels, the support members, the elastic members, the circuit boards and the belt parts used in the thirteenth exemplary embodiment to the fourteenth exemplary embodiment are not limited to the exemplified forms or structures and may be suitably changed.

This invention is based on Japanese Patent Application (Japanese Patent Application No. 2011-156535) filed on Jul. 15, 2011, and Japanese Patent Application (Japanese Patent Application No. 2011-271249) filed on Dec. 12, 2011, the content of which is incorporated herein by reference.

### INDUSTRIAL APPLICABILITY

The present invention is preferably applied to the mobile terminal in which the plate shaped member is provided which is mounted on the mounting surface along the direction of thickness of the casing and the fixing member is provided that fixes the plate shaped member to the casing.

The present invention is preferably applied to the mobile terminal in which the display device is supported by the casing, the protecting panel is laminated on the display device and the display device and the protecting panel are fixed to the casing.

The present invention is preferably applied to the mobile terminal in which the display device is accommodated in the casing, the protecting panel is laminated on the display device and the protecting panel is fixed to the casing.

### REFERENCE SIGNS LIST

10, 90, 100, 110, 120, 130, 310, 400, 450 . . . mobile terminal 12, 91, 102, 112, 122, 132, 311, 401 casing 16, 92 . . . display part 18, 93, 113, 123, 133 . . . plate shaped member (panel) 18A . . . surface of plate shaped member 18B . . . edge part of surface 20, 60, 70, 80, 95, 115, 125, 135 fixing member 21, 128, 138, 321, 363, 412 . . . first member 22, 82, 126, 136, 322, 364, 413 . . . second member 23, 83, 127, 137, 323, 365, 414 . . . third member 24 . . . fourth member 25 . . . fifth member 26, 96 . . . parting section 29, 62, 72 . . . bent part 35, 122C, 132C . . . first side surface 36, 122A. 132A . . . second side surface 37, 122B, 132B . . . third side surface 38 . . . fourth side surface 39 . . . planar angular part 41 . . . mounting surface 82A, 83A, 126A, 127A, 136A. 137A . . . central part in longitudinal direction 82B, 82C, 126B, 1260, 136B, 136C both end parts in longitudinal direction 95A . . . one end of fixing member 95B . . . the other end of fixing member L1, L2 . . . dimension of space 318, 404 . . . display device 318B . . . display end face 19, 405 . . . protecting panel 319A . . . protecting end face 319B, 4050 . . . surface of protecting panel 405B . . . side surface of protecting panel 320, 362, 411 support member 329 . . . sheet 404A . . . front side of display device 404B . . . side surface of display device 407 . . . elastic member 403 . . . circuit board 452 . . . belt part

1. A mobile terminal including:
a casing having a substantially rectangular form in plane with a prescribed thickness;
a plate shaped member mounted on a mounting surface in one side along the direction of thickness of the casing; and
a fixing member configured to fix the plate shaped member to the casing, wherein
the fixing member is formed substantially in a shape of a frame including a first member extending along a first side surface intersecting the mounting surface in the casing, a second member and a third member connected to the first member and respectively extending along a second side surface and a third side surface respectively adjacent to the first side surface, a fourth member connected to the second member, adjacent to the second side surface and extending along a part of a fourth side surface opposite to the first side surface, a fifth member connected to the third member and extending along a part of the fourth side surface and a parting section provided between the fourth member and the fifth member, and has a sectional form in which the first member to the fifth member are engaged with edge parts of a surface directed to an opposite side to the casing in the plate shaped member and engaged with stepped surfaces directed to an opposite side to the plate shaped member in the casing, and the fixing member is deformable so that a dimension of a space between the fourth member and the fifth member may be increased or decreased.

2. A mobile terminal according to claim 1, wherein
planar angular parts of the casing are formed in the shapes of circular arcs,
the fixing member has bent parts provided correspondingly to the angular parts, and
the bent parts have sectional forms engaged with the surface of the plate shaped member and the stepped surfaces.

3. A mobile terminal according to claim 1, wherein
a central part of at least one of the second member and the third member in the longitudinal direction is formed in a planar shape so that the central part is higher in its contact pressure to the casing than both end parts in the longitudinal direction.

4. A mobile terminal including:
a casing having a prescribed thickness;
a plate shaped member mounted on a mounting surface in one side along a direction of thickness of the casing; and
a fixing member substantially having the shape of C in section which is engaged with an edge part of a surface directed to an opposite side to the casing in the plate shaped member and engaged with a stepped surface directed to an opposite side to the plate shaped member in the casing, wherein
the fixing member is formed substantially in the shape of a frame turned along a side surface of the casing and having a parting section provided in a part and can be attached to the casing along an attaching direction parallel to the surface, and
one end and the other end in the fixing member can be more largely separated than a maximum dimension of the casing in the direction of width extending along the surface and intersecting at right angles to the attaching direction.

5. A mobile terminal including:
a casing;
a display device supported by the casing;
a protecting panel laminated on the display device; and
a support member which fixes the display device and the protecting panel to the casing,
wherein the support member includes a first member parallel to a display end face and a protecting end face which are along a same surface, a second member connected to the first member to cover an edge part in a surface of the protecting panel, and a third member provided in an opposite side to the second member in the first member and fixed to the casing.

6. A mobile terminal according to claim 5, wherein
the support member is formed in a shape of U in section in which the second member and the third member are substantially parallel to each other and a stepped surface with which the third member can be engaged is formed in a side surface of the casing.

7. A mobile terminal according to claim 5, wherein
the display end face and the protecting end face are provided along a same surface.

8. A mobile terminal according to claim 5, wherein the support member is formed with metal.

9. A mobile terminal according to claim 5, wherein a sheet is laminated on the surface of the protecting panel.

10. A mobile terminal including:
a casing;
a display device accommodated in the casing;
a protecting panel laminated on a front side of the display device;
an elastic member which covers a side surface of the display device and is interposed between the casing and the protecting panel; and
a support member which fixes the protecting panel to the casing,
wherein the support member includes a first member which faces a side surface of the protecting panel and the elastic member, a second member connected to the first member to cover an edge part in a surface of the protecting panel, and a third member provided in an opposite side to the second member in the first member and fixed to the casing.

11. A mobile terminal according to claim 10, further including a belt part connected to the elastic member and interposed between the display device and the protecting panel.

12. A mobile terminal according to claim 10, wherein the support member is formed with metal and electrically connected to a circuit board accommodated in the casing.
